(19) United States
(12) Patent Application Publication
(10) Pub. No.: US 2025/0343899 A1
(43) Pub. Date: Nov. 6, 2025

(54) ENCODING METHOD AND APPARATUS, DECODING METHOD AND APPARATUS, ENCODER, DECODER, CODE STREAM, AND STORAGE MEDIUM

(71) Applicant: GUANGDONG OPPO MOBILE TELECOMMUNICATIONS CORP., LTD., Dongguan (CN)

(72) Inventors: Yanzhuo MA, Dongguan (CN); Junyan HUO, Dongguan (CN); Fuzheng YANG, Dongguan (CN); Hongqing Du, Dongguan (CN); Ming LI, Dongguan (CN)

(73) Assignee: GUANGDONG OPPO MOBILE TELECOMMUNICATIONS CORP., LTD., Dongguan (CN)

(21) Appl. No.: 19/272,640

(22) Filed: Jul. 17, 2025

Related U.S. Application Data
(63) Continuation of application No. PCT/CN2023/073453, filed on Jan. 20, 2023.

(51) Int. Cl. H04N 19/105; H04N 19/159; H04N 19/176

(52) U.S. Cl. CPC H04N 19/105; H04N 19/159; H04N 19/176

(57) ABSTRACT

Disclosed in the embodiments of the present application are an encoding method and apparatus, a decoding method and apparatus, an encoder, a decoder, a code stream, and a storage medium. The encoding method is applied to an encoder, and comprises: determining a template of the current block and one or more prediction templates of the template of the current block; determining the weights of the one or more prediction templates according to the template of the current block and the one or more prediction templates; determining one or more first prediction blocks of the current block according to a prediction parameter of the current block; and fusing the one or more first prediction blocks according to the weights of the one or more prediction templates, so as to obtain a second prediction block of the current block.

### CROSS-REFERENCE TO RELATED APPLICATIONS

This application is a continuation of International Application No. PCT/CN2023/073453, filed on Jan. 20, 2023, the disclosure of which is hereby incorporated by reference in its entirety.

### TECHNICAL FIELD

Embodiments of this application relate to a video coding technology, but are not limited to a coding method and apparatus, an encoder, a decoder, a bitstream, and a storage medium.

### BACKGROUND

In the field of video coding, how to improve video compression efficiency is important. In a digitization process of a picture and a video, great data redundancy is generated, so that video compression becomes possible. There is a strong spatial correlation between adjacent parts or adjacent samples in the picture. According to intra prediction, prediction is performed by using spatial correlation between decoded samples around a current block and samples within the current block, thereby reducing spatial redundancy in video encoding based on a prediction result. There is also a strong similarity between adjacent frames in a video. In a video decoding technology, time redundancy between adjacent frames is eliminated by using an inter prediction method, thereby improving encoding efficiency.

Therefore, how to further improve the accuracy of intra prediction and inter prediction is to be solved, so as to improve video coding performance.

### SUMMARY

According to a coding method and apparatus, an encoder, a decoder, the bitstream, and the storage medium that are provided in this embodiment of this application, accuracy of the intra prediction and/or the inter prediction can be improved, so that video coding performance is improved.

The coding method and apparatus, the encoder, the decoder, the bitstream, and the storage medium provided in embodiments of this application are implemented as follows.

According to an aspect of embodiments of this application, an encoding method is provided. The method is applied to an encoder, and the method includes: determining a template of a current block and one or more prediction templates of the template of the current block; determining a weight of the one or more prediction templates according to the template of the current block and the one or more prediction templates; determining one or more first prediction blocks of the current block according to a prediction parameter of the current block; and fusing the one or more first prediction blocks by using the weights of the one or more prediction templates to obtain a second prediction block of the current block.

According to an aspect of embodiments of this application, a decoding method is provided. Th method is applied to a decoder, and the method includes: determining a template of a current block and one or more prediction templates of the template of the current block; determining a weight of the one or more prediction templates according to the template of the current block and the one or more prediction templates; determining one or more first prediction blocks of the current block according to a prediction parameter of the current block; fusing the one or more first prediction blocks by using the weight of the one or more prediction templates, to obtain a second prediction block of the current block; and determining a reconstructed value of the current block according to the second prediction block.

According to an aspect of embodiments of this application, an encoding apparatus is provided. The apparatus is applied to an encoder, and the apparatus includes: a first determining module, configured to determine a template of a current block and one or more prediction templates of the template of the current block; a second determining module, configured to determine a weight of the one or more prediction templates according to the template of the current block and the one or more prediction templates; a third determining module, configured to determine one or more first prediction blocks of the current block according to a prediction parameter of the current block; and a first fusion module, configured to fuse the one or more first prediction blocks by using weights of the one or more prediction templates to obtain a second prediction block of the current block.

According to an aspect of embodiments of this application, an encoder is provided, including a first memory and a first processor. The first memory is configured to store a computer program that is runnable on the first processor. The first processor is configured to run the computer program to perform the method described in the embodiments of this application.

According to an aspect of embodiments of this application, a decoding apparatus is provided, and is applied to a decoder. The apparatus includes: a fourth determining module, configured to determine a template of a current block and one or more prediction templates of the template of the current block; a fifth determining module, configured to determine a weight of the one or more prediction templates according to the template of the current block and the one or more prediction templates; a sixth determining module, configured to determine one or more first prediction blocks of the current block according to the prediction parameter of the current block; a second fusion module, configured to fuse the one or more first prediction blocks according to the weight of the one or more prediction templates, to obtain a second prediction block of the current block; and a seventh determining module, configured to determine a reconstructed value of the current block according to the second prediction block.

According to an aspect of embodiments of this application, a decoder is provided, including a second memory and a second processor. The second memory is configured to store a computer program that is runnable on the second processor. The second processor is configured to run the computer program to execute the decoding method in embodiments of this application.

According to an aspect of embodiments of this application, a bitstream is provided, where the bitstream is generated by using a residual block determined according to a second prediction block of a current block, and the second prediction block is obtained by using the encoding method.

According to an aspect of embodiments of this application, an electronic device is provided. The electronic device includes: a processor, configured to execute a computer program; and a computer readable storage medium storing a computer program, where the computer program is executed by the processor to implement the method in the embodiments of this application.

According to an aspect of embodiments of this application, a computer readable storage medium is provided, where the computer readable storage medium stores a computer program, and the computer program is executed to implement the method in the embodiments of this application.

It should be understood that the foregoing general description and the following detailed description are merely schematic and explanatory, and are not intended to limit this application.

### BRIEF DESCRIPTION OF DRAWINGS

The accompanying drawings herein are incorporated into the specification and constitute a part of the specification. The accompanying drawings illustrate embodiments that conform to this application, and are used together with the specification to describe the technical solutions of this application. Apparently, the accompanying drawings in the following description show only some embodiments of this application. A person of ordinary skill in the art may derive other drawings from these accompanying drawings without creative efforts.

The flowchart shown in the accompanying drawings is merely schematic, and is unnecessary to include all operations/steps, and is unnecessary to be performed in the order described. For example, some operations/steps may be further decomposed, and some operations/steps may be combined or partially combined. Therefore, an actual execution order may be changed according to an actual situation.

FIG. 1 is a schematic flowchart of a video encoder;

FIG. 2 is a schematic flowchart of a video decoder;

FIG. 3 is a schematic diagram of a network architecture of a coding system according to an embodiment of this application;

FIG. 4 is a schematic flowchart of implementing an encoding method according to an embodiment of this application;

FIG. 5 is a schematic diagram of a template of a current block and a reference region of the template of the current block according to an embodiment of this application;

FIG. 6 is a schematic flowchart of a method for determining a prediction template according to an embodiment of this application;

FIG. 7 is a schematic diagram of a HoG principle according to an embodiment of this application;

FIG. 8 is a schematic diagram of a histogram according to an embodiment of this application;

FIG. 9 is a schematic flowchart of a method for determining a prediction template according to an embodiment of this application;

FIG. 10A is a schematic flowchart of a method for determining a prediction template according to an embodiment of this application;

FIG. 10B is a schematic diagram of a reference line of a template of a current block according to an embodiment of this application;

FIG. 11 is a schematic flowchart of a method for determining a prediction template according to an embodiment of this application;

FIG. 12 is a schematic flowchart of implementing a decoding method according to an embodiment of this application;

FIG. 13 is a schematic diagram of a DIMD prediction procedure;

FIG. 14 is a schematic diagram of a TIMD prediction procedure;

FIG. 15 is a schematic diagram of a TMRL prediction procedure;

FIG. 16 is a schematic flowchart of inter-frame unidirectional weighted prediction;

FIG. 17 is a schematic flowchart of bidirectional weighted prediction;

FIG. 18 is a schematic flowchart of inter-frame weighted prediction;

FIG. 19 is a schematic diagram of a minMSE-based DIPF prediction procedure according to an embodiment of this application;

FIG. 20 is a schematic flowchart of an implementation of step 1904 according to an embodiment of this application;

FIG. 21 is a schematic flowchart of TIPF prediction according to an embodiment of this application;

FIG. 22 is a schematic flowchart of a specific implementation of step 2104 according to an embodiment of this application;

FIG. 23 is a schematic diagram of a neighboring block of a current block;

FIG. 24 is a schematic diagram of a TMRLF prediction procedure according to an embodiment of this application;

FIG. 25 is a schematic diagram of an IWPF prediction procedure according to an embodiment of this application;

FIG. 26 is a schematic diagram of an adjacent template curT of a current block and an adjacent template refT of a reference block;

FIG. 27 is a schematic structural diagram of an encoding apparatus according to an embodiment of this application;

FIG. 28 is a schematic structural diagram of a decoding apparatus according to an embodiment of this application;

FIG. 29 is a schematic structural diagram of an encoder according to an embodiment of this application;

FIG. 30 is a schematic structural diagram of a decoder according to an embodiment of this application.

### DESCRIPTION OF EMBODIMENTS

To make the objectives, technical solutions, and advantages of the embodiments of this application clearer, the following further describes the specific technical solutions of this application in detail with reference to the accompanying drawings in the embodiments of this application. The following embodiments are used to describe this application, but are not intended to limit the scope of this application.

Unless otherwise defined, all technical and scientific terms used in this specification have the same meaning as those commonly understood by those skilled in the art. The terms used in this specification are merely intended to describe the embodiments of this application, and are not intended to limit this application.

In the following description, the terms “some embodiments”, “this embodiment”, “embodiments of this application” and “examples” describe a subset of all possible embodiments, and it should be understood that “some embodiments” may be the same subset or different subsets of all possible embodiments, and may be combined with each other in the case of no conflicts.

The term “first/second/third” used in embodiments of this application is merely used to distinguish between objects, does not represent a specific order of the objects, does not indicate a specific limitation on a quantity of devices in the embodiments of this application, and does not constitute any limitation on the embodiments of this application.

The video coding standard mostly adopts a hybrid encoding framework based on a block. Each picture or sub-picture or frame in the video is partitioned into a square largest coding unit (LCU) or coding tree unit (CTU) of the same size (e.g., 128×128 or 64×64, etc.). Each largest coding unit or coding tree unit may be divided into rectangular coding units (CU) according to rules. The coding unit may be further divided into a prediction unit (PU) and/or a transform unit (TU), and the like. The hybrid encoding framework includes modules such as prediction, transform, quantization, entropy coding, and in-loop filter. The prediction module includes intra prediction (intra prediction) and inter prediction (inter prediction). The inter prediction includes motion estimation (motion estimation) and motion compensation (motion compensation). Since there is a strong correlation between adjacent samples in a frame of a video, spatial redundancy between adjacent samples is eliminated by using the intra prediction method in a video coding technology. Because of strong similarity between adjacent frames in the video, time redundancy between adjacent frames is eliminated by using the inter prediction method in the video coding technology, thereby improving coding efficiency.

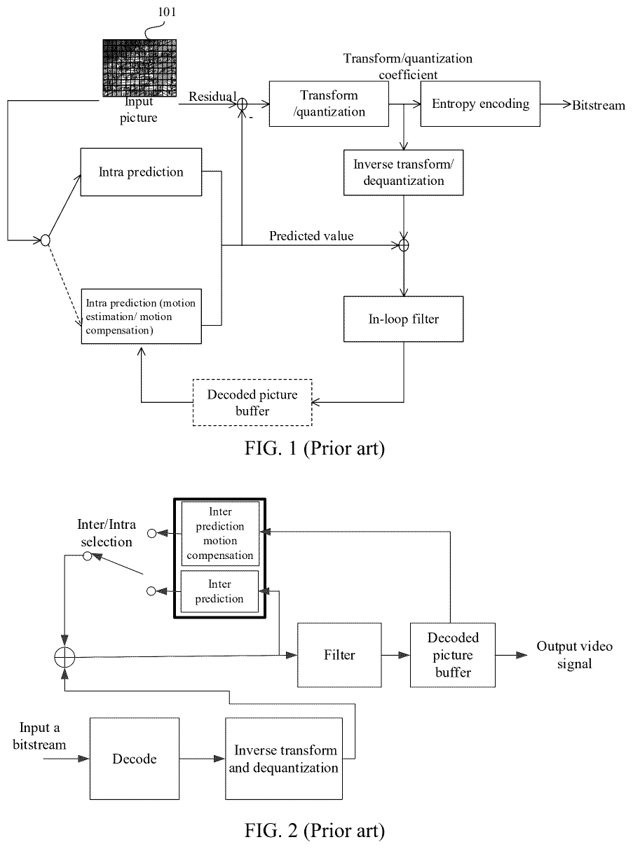

A basic procedure of video codec is shown in FIG. 1. In an encoding side, as shown in FIG. 1, a frame of picture 101 is divided into blocks, intra prediction or inter prediction is performed on a current block to generate a prediction block of the current block, the prediction block is subtracted from an original block of the current block to obtain a residual block, transformation and quantization are performed on the residual block to obtain a quantized coefficient matrix, and entropy coding is performed on the quantize coefficient matrix to output a bitstream. In a decoding side (not shown in the figure), a prediction block of the current block is generated by performing the intra prediction or the inter prediction on the current block. The bitstream is parsed to obtain a quantized coefficient matrix. A dequantization and inverse transform are performed on the quantized coefficient matrix to obtain a residual block, and the prediction block and the residual block are added to obtain a reconstructed block. The reconstructed block forms a reconstructed picture, and in-loop filtering is performed on the reconstructed picture in unit of the picture or the block to obtain a decoded picture. The encoding side also needs to perform a similar operation as the decoding side to obtain the decoded picture. In the encoding side, the obtained decoded picture may serve as a reference picture of the inter prediction for a subsequent frame. Block division information, mode information such as prediction, transform, quantization, entropy coding, and in-loop filtering, or parameter information determined by the encoding side needs to be included in the outputted bitstream if necessary. In the decoding side, as shown in FIG. 2, by parsing and analyzing the existing information, block division information, mode information such as prediction, transform, quantization, entropy coding, and in-loop filtering or or parameter information, the same as the encoding side, is determined, so as to ensure that the decoded picture obtained by the encoding side is the same as the decoded picture obtained by the decoding side. The decoded picture obtained by the encoding side is generally also referred to as a reconstructed picture. During prediction, the current block may be divided into prediction units. During transformation, the current block may be divided into transform units. Division of the prediction unit may be different from division of the transform unit.

A basic procedure of the video codec in the block-based hybrid encoding framework is described above. With development of the technology, some modules or steps of the framework or procedure may be optimized. The coding method provided in embodiments of this application is applicable to the basic procedure of the video codec in the block-based hybrid encoding framework, but is not limited to the framework and procedure. It may be learned by a person of ordinary skill in the art that, with evolution of the encoder and the decoder and emergence of a new service scenario, the method provided in embodiments of this application is also applicable to a similar technical problem.

The current block may be a current coding unit (CU), a current prediction unit (PU), or the like.

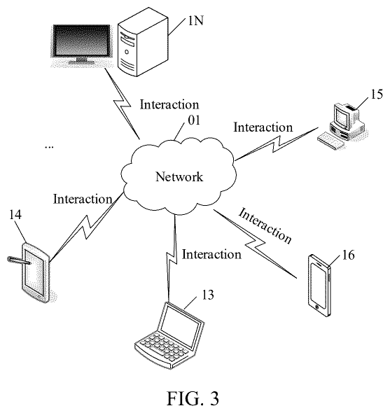

Further, an embodiment of this application further provides a network architecture of a coding system including an encoder and a decoder. FIG. 3 shows a schematic diagram of a network architecture of a coding system according to an embodiment of this application. As shown in FIG. 3, the network architecture includes one or more electronic devices 13 to IN and a communications network 01, where the electronic devices 13 to IN may perform video interaction by using the communications network 01. The electronic device may be implemented as various types of devices having a video decoding function. For example, the electronic device may include a smartphone, a tablet computer, a personal computer, a personal digital assistant, a navigator, a digital telephone, a video telephone, a television, a sensing device, and a server and so on. This is not specifically limited in embodiments of this application. Herein, the decoder or the encoder described in embodiments of this application may be the foregoing electronic device.

It should be noted that the method in embodiments of this application is mainly applied to the intra prediction and/or the inter prediction module shown in FIG. 1 and the intra prediction and/or the inter prediction module shown in FIG. 2. That is, embodiments of this application may be applied to the encoder or the decoder, or may even be applied to both the encoder and the decoder. However, applications of embodiments of this application are not limited.

It should be further noted that when applied to the intra prediction and/or the inter prediction module of the encoding side, “the current block” specifically refers to an encoding block on which the intra prediction and/or the inter prediction is currently to be performed; when applied to the intra prediction and/or the inter prediction module of the decoding side, “the current block” specifically refers to a decoding block on which the intra prediction and/or the inter prediction is currently to be performed.

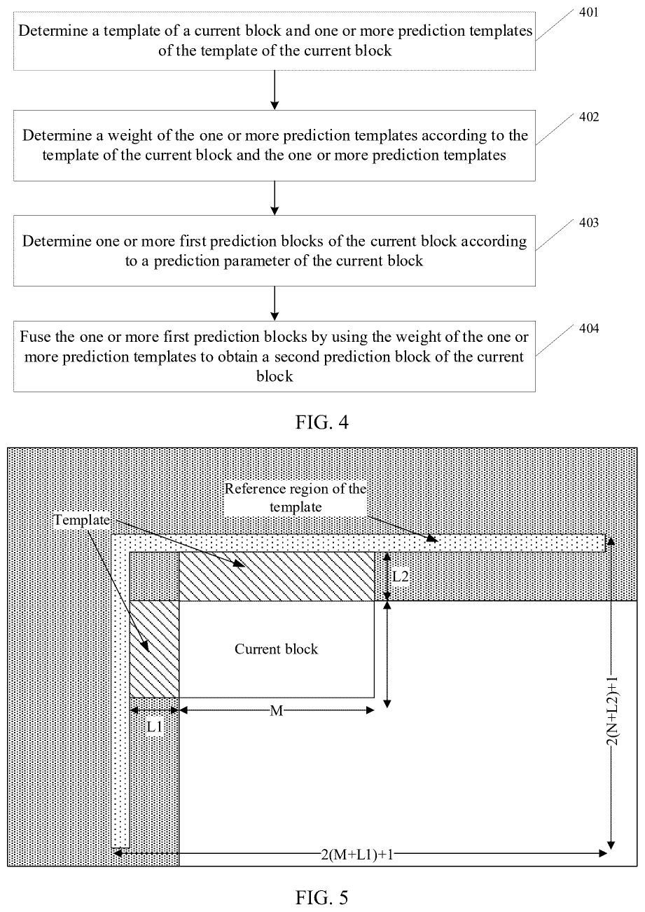

An embodiment of this application provides an encoding method. The method is applied to an encoder. FIG. 4 is a schematic flowchart of the encoding method according to an embodiment of this application. As shown in FIG. 4, the method includes the following steps 401 to 404.

In step 401, a template of a current block and one or more prediction templates of the template of the current block are determined.

In step 402, a weight of the one or more prediction templates is determined according to the template of the current block and the one or more prediction templates.

In step 403, one or more first prediction blocks of the current block are determined according to a prediction parameter of the current block.

In step 404, the one or more first prediction blocks are fused by using the weight of the one or more prediction templates to obtain a second prediction block of the current block.

In embodiments of this application, a weight of the one or more prediction templates is determined according to the template of the current block and one or more prediction templates of the template of the current block. One or more first prediction blocks of the current block are fused, so as to obtain a second prediction block of the current block. In this way, compared with fusion of one or more first prediction blocks of the current block by using a fixed weight, the weight is determined based on the template of the current block and one or more prediction templates of the template of the current block in embodiments of this application, so that the obtained weight has better adaptivity, that is, the weight changes with the change of the current block and the obtained weight conforms to an actual case of the current block, thereby improving prediction accuracy of the current block and further improving coding performance.

The following separately describes optional implementations of the foregoing steps and related nouns.

In step 401, the template of the current block and one or more prediction templates of the template of the current block are determined.

In embodiments of this application, a determining method, a size and a shape of the current block, and a relative position between the template and the current block are not limited. In some embodiments, the template of the current block may be a region adjacent or not adjacent to the current block. It is assumed that a height and a width of the obtained current block template are L2 and L1, L1=L2=3 in DIMD. However, L1 and L2 are not limited to be equal to 3. The encoder may also determine a size of the template adaptively by using a block size of the current block, may transmit the size of the template to the decoder in a form of bitstream, and the decoder obtains the size of the template by decoding the bitstream.

In embodiments of this application, the template of the current block may have multiple types of shapes such as L-shaped or a shape of symbol “−”. The L-shaped template may include an upper left template, an upper template, and a left template, or may include an upper left template, an upper template, an upper right template, a left upper, and/or a lower left template. The template of the current block may include only the upper template or only the left template, or may include only the upper template and the left template.

It may be understood that the prediction template of the template of the current block may also be understood as a prediction block/prediction value/reference block/reference value of the template of the current block. In some embodiments, the template of the current block may be predicted according to a prediction parameter of the template of the current block, to obtain some or all prediction templates of the template of the current block. The prediction parameter of the template of the current block is used to indicate one or more intra prediction modes and/or one or more motion parameters, and the motion parameters include an MV and/or a reference frame index.

Further, in some embodiments, the template of the current block may be predicted according to the prediction parameter of the template of the current block and a reference region/reference sample/reference sample of the template of the current block, to obtain some or all prediction templates of the template of the current block.

The reference region of the template of the current block may include an upper left region, an upper region, an upper right region, a left region, and/or a lower left adjacent region of the template. In some embodiments, if at least one the upper left region, the upper region, the upper right region, the left region, and/or the lower left region of the template is available/encoded/reconstructed, the one or more available regions are obtained as reference regions of the template of the current block. If the one or more regions are unavailable, the regions are not obtained. Certainly, the reference region of the template may also include samples/samples of a region that is not adjacent to the template, for example, may be reference samples/samples that are located in a second row above the template. Exemplarily, FIG. 5 shows a template of the current block and a reference region of the template of the current block.

In embodiments of this application, the prediction template may be determined by using multiple methods. The encoder may obtain some or all of the one or more prediction templates by using one or more prediction template determining methods described in the following. For example, the encoder may obtain one or more prediction templates of the template of the current block by using at least one embodiment of the following embodiment 1 to embodiment 5.

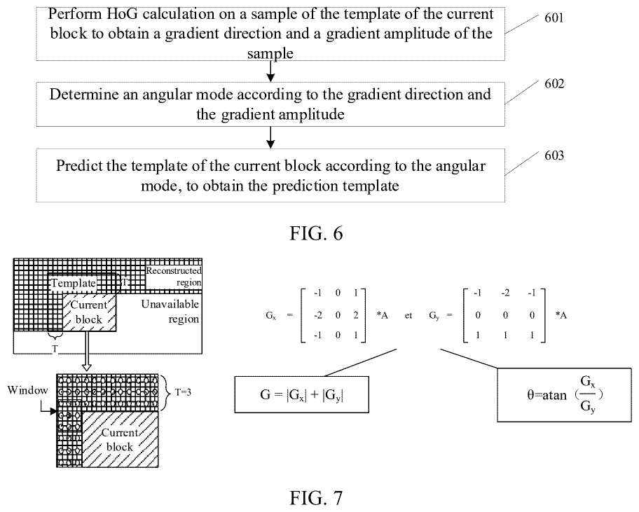

In embodiment 1, as shown in FIG. 6, the encoder may determine a prediction template by performing the following steps 601 to 603.

In step 601, Histogram of Oriented Gradient (HoG) calculation is performed on a sample of the template of the current block, to obtain a gradient direction and a gradient amplitude of the sample.

That is, the encoder may calculate a gradient direction and a gradient amplitude of the sample of the template of the current block according to a predefined horizontal filter and vertical filter. A size of the horizontal filter and a size of the vertical filter are not limited, which may be 2×2, 3×3, 4×4, or the like, or a size of the horizontal filter and a size of the vertical filter may be determined according to a size of the template of the current block. For example, the horizontal filter includes a sober filter, and the vertical filter includes a vertical sober filter.

In step 602, an angular mode is determined according to the gradient direction and the gradient amplitude.

In step 603, a template of the current block is predicted according to the angular mode to obtain a prediction template.

It may be understood that the determined angular mode is used to perform intra prediction on the template of the current block, so as to obtain a prediction template of the template of the current block.

In some embodiments, the encoder may convert the gradient direction to a predefined candidate angular mode, and determines the angular mode from the candidate angular mode according to the gradient amplitude. Certainly, in other embodiments, the encoder may not convert the gradient direction to the candidate angular mode, but directly determine the angular mode according to the gradient direction and the gradient amplitude.

Further, in some embodiments, the encoder may determine the angular mode by obtaining N angular modes according to candidate angular modes corresponding to N maximum gradient amplitudes. For example, the encoder determines the candidate angular modes corresponding to the N maximum gradient amplitudes as the N angular mode, where N is any value greater than 0, for example, N=2, 3, or 4. In some embodiments, the encoder may write the value of N to the bitstream.

In some embodiments, the encoder may also determine the angular mode by obtaining one or more angular modes according to a candidate angular mode corresponding to a gradient amplitude greater than or equal to a first threshold. For example, the encoder determines the candidate angular mode corresponding to the gradient amplitude greater than or equal to the first threshold as the angular mode.

In some embodiments, the encoder may determine the angular mode by obtaining one or more angular modes according to a candidate angular mode corresponding to a second gradient amplitude, where a difference between the second gradient amplitude and at least one first gradient amplitude is less than or equal to a second threshold. For example, the encoder determines the candidate angular mode corresponding to the above second gradient amplitude as the angular mode.

In embodiments of this application, a relationship between the first gradient amplitude and the second gradient amplitude is not limited. In some embodiments, a size of the first gradient amplitude is adjacent to the second gradient amplitude. For example, the size of the first gradient amplitude is just less than a size of the second gradient amplitude.

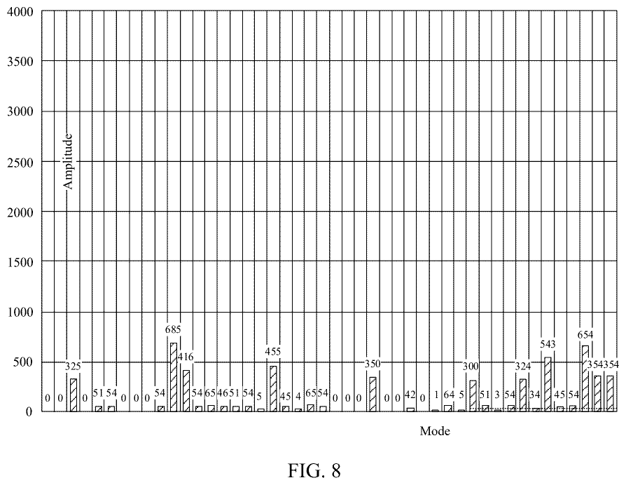

To facilitate understanding of the foregoing step 601 and step 602, the following provides exemplary description which does not constitute a limitation on the technical solution provided in embodiments of this application. For example, as shown in FIG. 7, the encoder separately calculates a horizontal gradient Gx and a vertical gradient Gy of a center sample/sample of the template of the current block by using a 3×3 horizontal sober filter and vertical sober filter. Then, an angle of the corresponding sample/sample may be calculated by using atan (Gy/Gx), and the angle is converted into one of 65 candidate angle modes IPM in VVC, and a sum of absolute values of Gx and Gy is used as a cumulative amplitude/gradient value of the candidate angle mode. The foregoing process may be repeated on each center sample/sample (or may be a part of the center samples/samples) of the template of the current block, to obtain a candidate angle mode histogram, as shown in FIG. 8. A horizontal coordinate of the histogram is an index of the candidate angle mode, and a vertical coordinate of the histogram is a gradient amplitude corresponding to the candidate angle mode.

In the candidate angle mode histogram, the candidate angle mode with first N largest gradient amplitudes is selected as an intra prediction mode (that is, the angle mode used to perform intra prediction). In embodiments of this application, the candidate angle mode with the first N largest gradient amplitudes may be directly obtained as an intra prediction mode. Alternatively, a first threshold may be set; and only when the gradient amplitude is greater than or equal to the first threshold, the candidate angle mode corresponding to the gradient amplitude is used as the intra prediction mode. Alternatively, a second threshold may be set; and only when a difference between adjacent gradient amplitudes is less than or equal to the second threshold, a candidate angle mode corresponding to the gradient amplitude is used as an intra prediction mode.

It may be understood that the encoding method described in embodiment 1 is improvement on a decoder side intra mode derivation (DIMD) method.

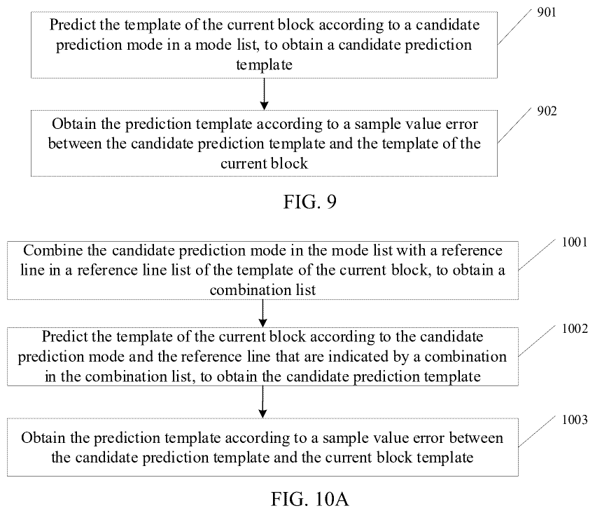

In embodiment 2, as shown in FIG. 9, the encoder may determine the prediction template by using the following steps 901 to 902:

In step 901, a template of the current block is predicted according to a candidate prediction mode in a mode list, to obtain a candidate prediction template.

In some embodiments, the candidate prediction mode in the mode list includes at least one of the following:
the angle mode obtained by performing the step described in embodiment 1;
a prediction mode in a Most Probable Mode (MPM) list;
a prediction mode in the MPM list in which a Planar mode is deleted;
an angle mode obtained by extending an angle pattern whose angle is greater than or equal to a fourth threshold in the MPM list; or an angle mode obtained by extending an angle mode whose angle is less than or equal to a fifth threshold in the MPM list.

Further, in some embodiments, in the MPM list, a DC mode is after or before an angle mode constructed based on an adjacent block of the current block.

Further, in some embodiments, in the mode list, the N angle modes are after or before an angle mode constructed based on the adjacent block of the current block.

In some embodiments, the process of performing step 901 by the encoder may include: predicting the template of the current block according to a sample value of a reference region of the template of the current block and the candidate prediction mode, to obtain the candidate prediction template. The reference region includes a non-adjacent region and/or an adjacent region of the template of the current block. Further, in some embodiments, the reference region is a coded region/reconstructed region. For example, in some embodiments, the reference region includes an upper left region, an upper region, an upper right region, a left region, and/or a lower left region of the template of the current block.

In step 902, the prediction template is obtained according to a sample value error between the candidate prediction template and the template of the current block.

In some embodiments, the prediction template may be determined as follows. N prediction templates are obtained according to candidate prediction templates corresponding to N minimum sample value errors; and/or one or more prediction templates are obtained according to a candidate prediction template corresponding to a sample value error less than or equal to a third threshold, where N is any value greater than 0, for example, N=2, 3, or 4. In some embodiments, the encoder may write the value of N to the bitstream.

In embodiments of this application, a type of the sample value error is not limited. The sample value error represents an error between a sample value of a candidate prediction template and a sample value of the template of the current block. In some embodiments, a type of the sample value error is at least one of: sum of absolute transformed difference (SATD), sum of absolute difference (SAD), mean absolute difference (MAD), mean absolute error (MAE), normalized correlation coefficient (NCC), mean square error (MSE), or sum of square error (SSE).

It may be understood that the encoding method described in embodiment 2 is improvement on the template based intra mode derivation and fusion (Template based intra mode derivation and fusion, TIMD) method.

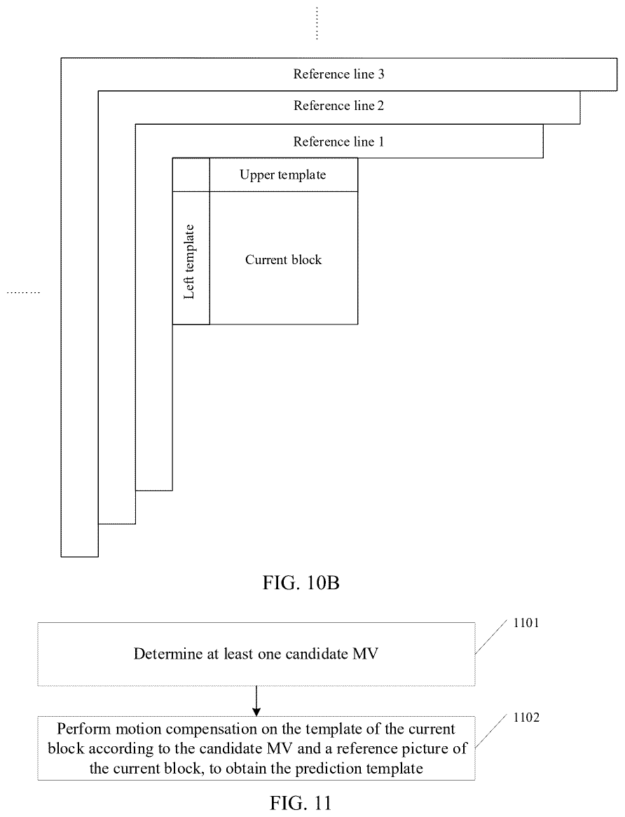

In embodiment 3, as shown in FIG. 10A, the encoder may determine the prediction template by using the following steps 1001 to 1003.

In step 1001, a candidate prediction mode in the mode list is combined with a reference row in a reference row list of the template of the current block, to obtain a combination list.

It may be understood that in a template-based multiple reference line intra prediction (TMRL), a template of the current block is a first row and a first column of samples/samples that are adjacent to the current block. Alternatively, the template of the current block may also be first M rows and first M columns of samples that are adjacent to the current block, where M is any value greater than 1. For example, as shown in FIG. 10B, the template of the current block is a left adjacent region and an upper adjacent region of the current block, and reference lines may be reference lines 1, 2, and 3 and so on shown in FIG. 10B.

In some embodiments, the reference line list of the current block includes an index indicating the reference line, and indexes of the reference line included in the reference line list are not limited in embodiments of this application. For example, in some embodiments, the reference line indexes included in the reference line list are {1, 3, 5, 7, 12} or {1, 4, 5, 7, 10, 12} or {1, 2, 3, 7, 10, 11}.

It may be understood that for the current block, extended reference lines used by the TMRL include 5 reference lines indicated by {1, 3, 5, 7, 12}, and an extended MPM list includes 10 candidate prediction modes. Therefore, a TMRL combination list may be established, and the combination list includes 5×10=50 combinations in total. Each combination includes one index indicating the candidate prediction mode and at least one index indicating the reference line. The encoder may predict the template of the current block according to the candidate prediction mode and the at least one reference line indicated by one combination, so as to obtain the candidate prediction template.

In embodiments of this application, for the mode list in step 1001, reference may be made to the foregoing description of the mode list. That is, the candidate prediction mode in the mode list may be determined according to the foregoing method. Details are not described herein again.

In step 1002, a template of the current block is predicted according to the candidate prediction mode and the reference line that are indicated by a combination in the combination list, to obtain a candidate prediction template.

In step 1003, the prediction template is obtained according to a sample value error between the candidate prediction template and the template of the current block.

In some embodiments, the prediction template may be determined as follows. N prediction templates are obtained according to candidate prediction templates corresponding to N minimum sample value errors; and/or one or more prediction templates are obtained according to a candidate prediction template corresponding to a sample value error less than or equal to a third threshold, where N is any value greater than 0, for example, N=2, 3, or 4. In some embodiments, the encoder may write the value of N to the bitstream.

In embodiments of this application, a type of the sample value error is not limited. The sample value error represents an error between a sample value of a candidate prediction template and a sample value of the template of the current block. In some embodiments, a type of the sample value error is at least one of: sum of absolute transformed difference (SATD), sum of absolute difference (SAD), mean absolute difference (MAD), mean absolute error (MAE), normalized correlation coefficient (NCC), mean square error (MSE), or sum of square error (SSE).

It may be understood that the encoding method in embodiment 3 is improvement on TMRL.

In embodiment 4, as shown in FIG. 11, the encoder may determine a prediction template by using the following steps 1101 to 1102.

In step 1101, at least one candidate MV is determined.

In some embodiments, the encoder may obtain at least one candidate MV according to a Merge candidate list or an AMVP candidate list. Further, in some embodiments, the encoder may obtain first N candidate MVs in the Merge candidate list or the AMVP candidate list.

In embodiments of this application, the candidate MV in the Merge candidate list or the AMVP candidate list is a MV subjected to template matching, DMVR, and/or Multipass DMVR refinement.

In some embodiments, the encoder may further write information related to the at least one candidate MV into a bitstream. In this case, step 1101 is unnecessary to be performed by the decoder.

In step 1102, motion compensation is performed on the template of the current block according to the candidate MV and the reference frame of the current block, to obtain the prediction template.

In some embodiments, the reference frame of the current block is a forward reference frame or a backward reference frame of the current block.

In embodiments of this application, the prediction template that participates in determining a weight may include a first offset item, or may not include a first offset item. Accordingly, the first prediction block that participates in determining a second prediction block may include a second offset item, or may not include a second offset item.

In embodiments of this application, the prediction template that participates in determining a weight may include a first non-linear item, or may not include a first non-linear item. Accordingly, the first prediction block that participates in determining a second prediction block may include a second non-linear item, or may not include a second non-linear item.

In some embodiments, the first offset item indicates a template generated according to a sample value bit depth of the template of the current block, that is, the one or more prediction templates further include a template generated according to the sample value bit depth of the template of the current block. Accordingly, the second offset item indicates a block generated according to the sample value bit depth of the current block, that is, the one or more first prediction blocks further include a block generated according to the sample value bit depth of the current block.

In some embodiments, the first non-linear item indicates a prediction template obtained by performing transformation on the candidate prediction template with a minimum sample value error, that is, the one or more prediction templates further include a prediction template obtained by performing transformation (for example, square calculation) on the candidate prediction template with a minimum sample value error. Accordingly, the second non-linear item indicates a prediction block obtained by performing the transform (for example, square calculation) on the first prediction block corresponding to the candidate prediction template with a minimum sample value error, that is, the one or more first prediction blocks further include a prediction block obtained by performing the transform on the first prediction block corresponding to the candidate prediction template with a minimum sample value error.

It may be understood that the first prediction block corresponding to the candidate prediction template with a minimum sample value error is the first prediction block obtained by predicting the current block according to a prediction mode for obtaining the candidate prediction template with a minimum sample value error.

In some embodiments, the prediction template that participates in determining the weight may further include a third offset item, where the third offset item indicates a prediction template obtained by predicting the template of the current block according to a specific prediction mode or a specific MV. The first prediction block that participates in determining the second prediction block may further include a fourth offset item, where the fourth offset item refers to a prediction block obtained by predicting the current block according to the specific prediction mode or the specific MV. Based on this, in some embodiments, the encoder needs to perform mode/MV duplication check. In a case that it is determined that the specific prediction mode is different from the intra prediction mode/MV indicated by the prediction parameter, the encoder predicts the template of the current block according to the specific prediction mode/the specific MV to obtain the first prediction module.

For example, in some embodiments, the specific prediction mode includes a Planar mode and/or a DC mode.

In embodiments of this application, the one or more prediction templates further include a prediction template obtained by predicting the template of the current block based on an intermediate prediction mode when a fusion operation is not performed in Chroma Fusion, OBMC, MHP, and/or SGPM methods.

In some embodiments, when a quantity of the one or more prediction templates is less than N, at least one of the first offset item, the third offset item, the first nonlinear item or the first preset value is added to the prediction templates to obtain N prediction templates. Accordingly, at least one of the second offset item, the fourth offset item, the second non-linear item or the second preset value is added to the first prediction blocks to obtain N first prediction blocks. For example, the first preset value is equal to 0.

In embodiment 5, the process of determining a prediction template by the encoder may include: determining at least one candidate BV; and determining a prediction template of the template of the current block according to the candidate BV, the current block, and a current picture.

In some embodiments, the encoder may obtain at least one candidate BV according to the Merge candidate list, the AMVP candidate list, and/or a preset value. Further, in some embodiments, the first N candidate BVs in the Merge candidate list or the AMVP candidate list are obtained. For example, the preset value is equal to 0.

The IBC can significantly improve the compression efficiency of the screen content coding, so the IBC is used for the screen content coding from HEVC to VVC. The screen content is different from a camera captured content. The screen content is generated by a computer, has no noise, includes text, computer graphics, and has a clear boundary. The screen content includes a large quantity of repeated content. It may be considered that the IBC applies the inter prediction method to the intra prediction. As mentioned above, in the inter prediction, the reference block on the reference picture is used as a prediction block of the current block, and the reference picture is not a current picture. According to the IBC, a block is searched for from a decoded part or a reconstructed part of the current picture, to serve as a prediction block of the current block. IBC is also referred to as intra picture block compensation or current picture referencing (CPR). In the IBC, block vector BV (block vector) is used to indicate a position difference between the current block and the reference block, which is similar to the MV of inter prediction. The encoder determines a best matching block of the current block in a search range by using the block matching method, and encodes the BV. The BV may be encoded by using multiple methods. Details are not described herein again. The IBC may be considered as an intra prediction method, or may be considered as another type of prediction method independent of the intra prediction and the inter prediction.

In step 402, a weight of the one or more prediction templates is determined according to the template of the current block and the one or more prediction templates.

In some embodiments, the process of performing step 402 by the encoder may include: determining a weight of the one or more prediction templates according to the template of the current block and the one or more prediction templates, so as to minimize a sample value error between the template of the current block and a target predicted value of the template of the current block. The target predicted value is equal to a weighted sum of sample values of the one or more prediction templates.

A type of the sample value error is not limited, and the type of the sample value error is one of: MSE, SATD, SAD, MAD, MAE, NCC, and SSE.

Further, in some embodiments, the encoder may determine an autocorrelation matrix of the prediction template according to a sample value of the prediction template; determines a cross-correlation vector between the prediction template and the template of the current block according to the sample value of the prediction template and the sample value of the template of the current block; and determining a weight of the one or more prediction templates according to the autocorrelation matrix and the cross-correlation vector.

Taking the sample value error as an example, an MSE calculation formula is as follows:

$$M S E = \frac{1}{P} {\sum }_{p = 0}^{P - 1} {( refpred {T}_{p} - c u r T )}^{2} = \frac{1}{P} {\sum }_{p = 0}^{P - 1} {( {\sum }_{p = 0}^{P - 1} {w}_{p}^{*} {refT}_{p} - c u r T )}^{2} .$$

For convenience of representing the MSE calculation formula, E denotes mean squared error MSE., that is:

$$M S E = E [ {( refpred {T}_{p} - c u r T )}^{2} ] = E [ {( {\sum }_{p = 0}^{P - 1} {w}_{p} \cdot {refT}_{p} - c u r T )}^{2} ] .$$

In which, refTₚ represents a sample value of a p-th prediction template, curT represents a sample value of the template of the current block, wₚ represents a weight of the p-th prediction template, and p represents a total quantity of prediction templates.

The weight wₚ of the first prediction block corresponding to each prediction template is derived by minimizing the MSE.

(1) partial derivative on wₚ is calculated and let the partial derivative to be 0:

$$\frac{\partial M S E}{\partial {w}_{m}} = E [ 2 ( {\sum }_{p = 0}^{P - 1} {w}_{p} \cdot {refT}_{p} - c urT ) \cdot {refT}_{p} ] , m = 0 , 1 , … , P - 1$$

$$E [ 2 ( {\sum }_{p = 0}^{P - 1} {w}_{p} \cdot {refT}_{p} - c urT ) \cdot {refT}_{p} ] = 0$$

the following equation may be obtained according to the above two formulars:

$${\sum }_{p = 0}^{P - 1} {w}_{p} \cdot E ( {refT}_{p} \cdot {refT}_{p} ) = E ( curT \cdot {refT}_{p} )$$

(2) After the prediction templates refT₀, refT₁, . . . , refT_{P-1} are determined, the equation obtained in step (1) is expanded into a matrix form:

$$[ \begin{matrix}\begin{matrix}{\sum }_{i ∈ {refT}_{0}} ( refT [ i ] [ 0 ] \cdot \\ refT [ i ] [ 0 ] )\end{matrix} & \begin{matrix}{\sum }_{i ∈ {refT}_{0}} ( refT [ i ] [ 1 ] \cdot \\ refT [ i ] [ 0 ] )\end{matrix} & … & \begin{matrix}{\sum }_{i ∈ {refT}_{0}} ( refT [ i ] [ P - 1 ] \cdot \\ refT [ i ] [ 0 ] )\end{matrix} \\ \begin{matrix}{\sum }_{i ∈ {refT}_{1}} ( refT [ i ] [ 0 ] \cdot \\ refT [ i ] [ 1 ] )\end{matrix} & \begin{matrix}{\sum }_{i ∈ {refT}_{1}} ( refT [ i ] [ 1 ] \cdot \\ refT [ i ] [ 1 ] )\end{matrix} & … & \begin{matrix}{\sum }_{i ∈ {refT}_{1}} ( refT [ i ] [ P - 1 ] \cdot \\ refT [ i ] [ 1 ] )\end{matrix} \\ ⋮ & ⋮ & ⋱ & ⋮ \\ \begin{matrix}{\sum }_{i ∈ {refT}_{P - 1}} ( refT [ i ] [ 0 ] \cdot \\ refT [ i ] [ P - 1 ] )\end{matrix} & \begin{matrix}{\sum }_{i ∈ {refT}_{P - 1}} ( refT [ i ] [ 1 ] \cdot \\ refT [ i ] [ P - 1 ] )\end{matrix} & … & \begin{matrix}{\sum }_{i ∈ {refT}_{P - 1}} ( refT [ i ] [ P - 1 ] \cdot \\ refT [ i ] [ P - 1 ] )\end{matrix}\end{matrix} ] \cdot [ \begin{matrix}{w}_{0} \\ {w}_{1} \\ ⋮ \\ {w}_{P - 1}\end{matrix} ] = [ \begin{matrix}{\sum }_{l ∈ {refT}_{0}} ( curT \cdot refT [ i ] [ 0 ] ) \\ {\sum }_{l ∈ {refT}_{1}} ( curT \cdot refT [ i ] [ 1 ] ) \\ ⋮ \\ {\sum }_{l ∈ {refT}_{P - 1}} ( curT \cdot refT [ i ] [ P - 1 ] )\end{matrix} ]$$

(3) Since both the autocorrelation matrix and the cross-correlation vector in (2) are known, weights w0, . . . w_{P-1} of prediction samples corresponding to each candidate reference item may be calculated by solving the linear equation set in (2).

In step 403, one or more first prediction blocks of the current block are determined according to the prediction parameter of the current block.

In some embodiments, the encoder may determine a first prediction block of the current block according to the intra prediction mode indicated by the prediction parameter; and/or the encoder may determine the first prediction block of the current block according to the motion parameter of the current block indicated by the prediction parameter. The motion parameter includes at least one of the following parameters: an MV or a reference frame index. The “reference frame” described in embodiments of this application may also be understood as a reference picture.

In embodiments of this application, a prediction parameter of the current block is the same as a prediction parameter of a template of the current block. That is, the prediction mode for obtaining the prediction template is also used to obtain the first prediction block of the current block. In this way, a prediction template is associated with a first prediction block by using a same prediction mode. Therefore, a weight of the prediction template is a weight of the associated first prediction block.

In step 404, the one or more first prediction blocks are fused by using the weight of the one or more prediction templates, to obtain a second prediction block of the current block.

In some embodiments, for intra prediction or unidirectional inter prediction, the encoder may determine a residual block of the current block according to the second prediction block of the current block, and generates a bitstream according to the residual block.

In another embodiments, for the bidirectional inter prediction, assuming that the second prediction block is a prediction block of the current block obtained based on the forward reference frame, and the third prediction block is a prediction block of the current block obtained based on the backward reference frame, the encoder needs to perform weighted fusion on the second prediction block and the third prediction block to obtain a fourth prediction block. The encoder determines a residual block of the current block according to the fourth prediction block of the current block, and generates a bitstream according to the residual block. A method for determining the third prediction block is substantially the same as a method for determining the second prediction block, and the two methods differ only in a reference frame for inter prediction.

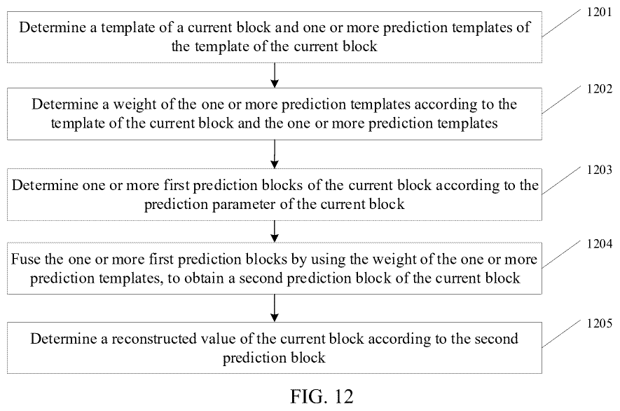

An embodiment of this application further provides a decoding method. The decoding method is applied to a decoder. FIG. 12 is a schematic flowchart of a decoding method according to an embodiment of this application. As shown in FIG. 12, the method includes the following steps 1201 to 1205.

In step 1201, a template of a current block and one or more prediction templates of the template of the current block are determined.

In step 1202, a weight of the one or more prediction templates is determined according to the template of the current block and the one or more prediction templates.

In step 1203, one or more first prediction blocks of the current block are determined according to the prediction parameter of the current block.

In step 1204, the one or more first prediction blocks are fused by using the weight of the one or more prediction templates to obtain a second prediction block of the current block.

In step 1205, a reconstructed value of the current block is determined according to the second prediction block.

In some embodiments, the decoder decodes the bitstream to determine a residual block corresponding to the current block, and determines a reconstructed value of the current block according to the residual block and the second prediction block.

In some embodiments, the decoder may determine the first prediction block of the current block according to the intra prediction mode indicated by the prediction parameter. In some embodiments, the decoder may determine the first prediction block of the current block according to the motion parameter of the current block indicated by the prediction parameter.

In some embodiments, the motion parameter includes at least one of the following parameters: a motion vector, or a reference frame index.

In some embodiments, the prediction parameter of the current block is the same as a prediction parameter of the template of the current block.

In some embodiments, the process of determining a prediction template of the template of the current block by the decoder may include: performing HoG calculation on a sample of the template of the current block to obtain a gradient direction and a gradient amplitude of the sample; determining an angular mode according to the gradient direction and the gradient amplitude; and predicting the template of the current block according to the angular mode to obtain the prediction template.

In some embodiments, the process of determining the angular mode according to the gradient direction and the gradient amplitude may include: converting the gradient direction into a predefined candidate angular mode; and determining the angular mode from the candidate angular mode according to the gradient amplitude.

In some embodiments, the process of determining the angular mode according to the gradient amplitude may include: obtaining N angular modes according to candidate angular modes corresponding to N maximum gradient amplitudes; and/or obtaining one or more angular modes according to the candidate angular mode corresponding to the gradient amplitude greater than or equal to a first threshold; and/or obtaining one or more angular modes according to a candidate angular mode corresponding to a second gradient amplitude, where a difference between the second gradient amplitude and the at least one first gradient amplitude is less than or equal to a second threshold.

The decoder may obtain a value of N by parsing the bitstream, or may determine the N angular modes by using a method similar to the method used in the encoding side.

In some embodiments, a size of the at least one first gradient amplitude is adjacent to the second gradient amplitude.

In some embodiments, the process of determining the prediction template of the template of the current block by the decoder may include: predicting the template of the current block according to the candidate prediction mode in the mode list to obtain the candidate prediction template; and obtaining the prediction template according to a sample value error between the candidate prediction template and the template of the current block.

In some embodiments, the process of obtaining the prediction template according to a sample value error between the candidate prediction template and the template of the current block may include: obtaining N prediction templates according to candidate prediction templates corresponding to N minimum sample value errors; and obtaining the one or more prediction templates according to a candidate prediction template corresponding to the sample value error less than or equal to a third threshold.

In some embodiments, a type of the sample value error is at least one of SATD, SAD, MAD, MAE, NCC, MSE, SSE.

In some embodiments, the candidate prediction mode in the mode list includes at least one of the following: an angular mode obtained by performing the above steps; a prediction mode in the MPM list; a prediction mode in the MPM list in which a Planar mode is deleted; an angular mode obtained by extending an angular mode whose angle is greater than or equal to a fourth threshold in the MPM list; or an angular mode obtained by extending an angular mode whose angle is less than or equal to a fifth threshold in the MPM list.

In some embodiments, in the MPM list, a DC mode is after or before an angular mode constructed based on a neighboring block of the current block.

In some embodiments, in the mode list, the N angular modes are after or before an angular mode constructed based on a neighboring block of the current block.

In some embodiments, the process of predicting a template of the current block according to a candidate prediction mode in a mode list to obtain a candidate prediction template includes: predicting the template of the current block according to a sample value of a reference region of the template of the current block and the candidate prediction mode to obtain the candidate prediction template. The reference region includes a non-adjacent region and/or an adjacent region of the template of the current block.

In some embodiments, the reference region includes an upper left region, an upper region, an upper right region, a left region, and/or a lower left region of the template of the current block.

In some embodiments, the process of predicting the template of the current block according to the candidate prediction mode in the mode list to obtain a candidate prediction template includes: combining the candidate prediction mode in the mode list with a reference line in a reference line list of the template of the current block, to obtain a combination list; and predicting the template of the current block according to the candidate prediction mode and the reference line that are indicated by a combination in the combination list, to obtain the candidate prediction template.

In some embodiments, reference line indexes included in the reference line list are {1,3,5,7, 12} or {1,4,5,7,10,12} or {1,2,3,7,10, 11}.

In some embodiments, the process of determining a prediction template of the template of the current block by the decoder may include: determining at least one candidate BV; and determining the prediction template of the template of the current block according to the candidate BV, the current block, and a current picture.

In some embodiments, the encoder may obtain at least one candidate BV according to the Merge candidate list, the AMVP candidate list, and/or a preset value. Further, in some embodiments, first N candidate BVs in the Merge candidate list or the AMVP candidate list are obtained. For example, the preset value is equal to 0.

In some embodiments, the process of determining a prediction template of the template of the current block by the decoder may include: determining at least one candidate MV; and performing motion compensation on the template of the current block according to the candidate MV and the reference frame of the current block, to obtain the prediction template.

In embodiments of this application, the decoder may parse the bitstream to obtain the at least one candidate MV, or may determine the at least one candidate MV by performing an operation similar to that performed at the encoding side.

In some embodiments, the reference frame of the current block is a forward reference frame or a backward reference frame of the current block.

In some embodiments, the process of determining at least one candidate MV includes: obtaining at least one candidate MV according to a Merge candidate list or an AMVP candidate list.

In some embodiments, the process of obtaining at least one candidate MV according to the Merge candidate list or the AMVP candidate list includes: obtaining first N candidate MVs in the Merge candidate list or the AMVP candidate list.

In some embodiments, the candidate MV in the Merge candidate list or the AMVP candidate list is an MV subjected to template matching, DMVR and/or Multipass DMVR refinement; and/or the candidate MV in the Merge candidate list or the AMVP candidate list is a candidate MV that is ranked according to an agreed sequence for an original candidate list.

Certainly, the candidate MV in the Merge candidate list or the AMVP candidate list may also be an unrefined MV.

In some embodiments, the one or more prediction templates further include a first offset item, where the first offset item indicates a template generated according to a sample value bit depth of the template of the current block. The one or more first prediction blocks further include a second offset item, where the second offset item indicates a block generated according to the sample value bit depth of the current block.

In some embodiments, the one or more prediction templates further include a third offset item, where the third offset item indicates a prediction template obtained by predicting a template of the current block according to a specific prediction mode or a specific MV. The one or more first prediction blocks further include a fourth offset item, where the fourth offset item indicates a prediction block obtained by predicting the current block according to the specific prediction mode or the specific MV.

In some embodiments, the specific prediction mode includes a Planar mode and/or a DC mode.

In some embodiments, the method further includes: predicting the template of the current block according to the specific prediction mode, in a case that it is determined that the specific prediction mode is different from an intra prediction mode indicated by the prediction parameter.

In some embodiments, the method further includes: predicting the template of the current block according to the specific MV, in a case that it is determined that the specific MV is different from an MV of the current block indicated by the prediction parameter.

In some embodiments, the one or more prediction templates further include a first nonlinear item, where the first nonlinear item indicates a prediction template obtained by performing transformation on a candidate prediction template with a minimum sample value error. The one or more first prediction blocks further include a second non-linear item, where the second non-linear item indicates a prediction block obtained by performing transformation on the first prediction block corresponding to the candidate prediction template with a minimum sample value error.

In some embodiments, the transformation includes square calculation.

In some embodiments, the one or more prediction templates further include a prediction template obtained by predicting the template of the current block based on an intermediate prediction mode when a fusion operation is not performed in the Chroma Fusion, OBMC, MHP, and/or SGPM methods.

In some embodiments, when a quantity of the one or more prediction templates is less than N, at least one of the first offset item, the third offset item, the first nonlinear item or the first preset value is added to the prediction templates to obtain N prediction templates. Accordingly, at least one of the second offset item, the fourth offset item, the second non-linear item or the second preset value are added to the first prediction blocks to obtain N first prediction blocks. For example, the first preset value is equal to 0.

In some embodiments, the process of determining a weight of the one or more prediction templates according to the template of the current block and the one or more prediction templates includes: determining the weight of the one or more prediction templates according to the template of the current block and the one or more prediction templates, so as to minimize a sample value error between the template of the current block and a target predicted value of the template of the current block. The target predicted value is equal to a weighted sum of sample values of the one or more prediction templates.

In some embodiments, the process of determining a weight of the one or more prediction templates according to the template of the current block and the one or more prediction templates includes: determining an autocorrelation matrix of the prediction template according to a sample value of the prediction template; determining a cross-correlation vector between the prediction template and the template of the current block according to the sample value of the prediction template and the sample value of the template of the current block; and determining the weight of the one or more prediction templates according to the autocorrelation matrix and the cross-correlation vector.

In some embodiments, a type of the sample value error is one of: MSE, SATD, SAD, MAD, MAE, NCC, or SSE.

It should be noted that, for technical details not disclosed in the embodiments of the decoding method, one may refer to the foregoing description of the embodiments of the encoding method.

(1) DIMD is an intra prediction technology adopted by both the encoding side and the decoding side. In this technology, adjacent 4 rows and 4 columns of reconstructed samples are used as a template, and HoG calculation is performed on samples in the template by using a window with a size of 3×3 around the current block. Horizontal and vertical Sobel filters are used to calculate the HoG, an angular mode corresponding to each sample and a corresponding amplitude value (abs (iDx)+abs (iDy)) are derived according to the obtained horizontal gradient iDy and vertical gradient iDx of the samples, and the amplitude values are accumulated. After calculation for all samples in the template is completed, intra prediction modes IPM (Intra Prediction Mode) corresponding to the two highest histogram cumulative amplitude values ampl1 and ampl2 are selected for the current encoding block, denoted as mode1 and mode2. Weighted fusion is performed on predicted values obtained by using the two prediction modes and predicted values obtained by the planar mode, to obtain the final intra prediction value. A weight of the predicted values of the two intra prediction mode derived from the histogram is determined by the magnitude ampl1 and the ampl2 of the histogram corresponding to the intra prediction mode, and the predicted value of the Planar mode has a fixed weight.

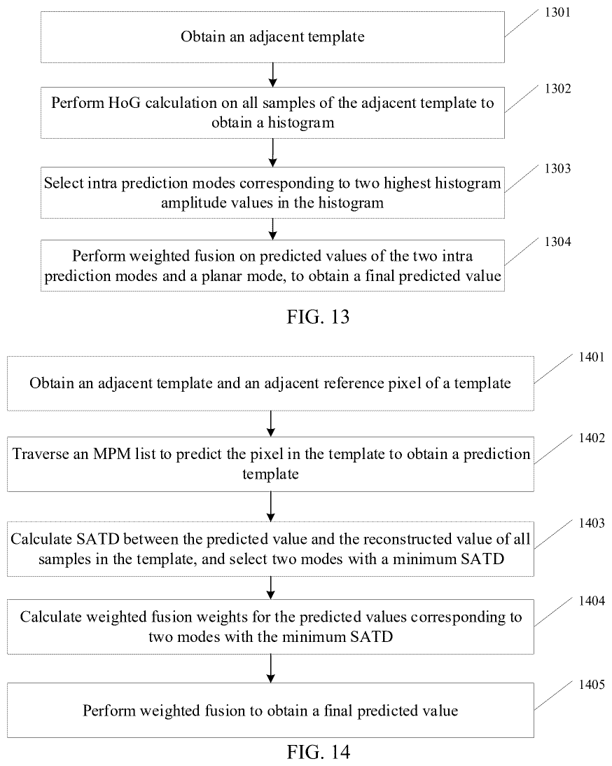

The DIMD prediction flowchart is shown in FIG. 13.

Weights w1 and w2 of mode1 and mode2 in DIMD are calculated as follows, and a weight of the planar mode is w3:

$$w 1 = \frac{43}{64} \times \frac{ampl 1}{ampl 1 + ampl 2}$$

$$w 2 = \frac{43}{64} \times \frac{ampl 2}{ampl 1 + ampl 2}$$

$$w 3 = \frac{21}{64}$$

The DIMD prediction value is calculated as follows:

$$pred = w 1 \times {pred}_{mode 1} + w 2 \times {pred}_{mode 2} + w 3 \times {pred}_{planar}$$

in which, pred is a final predicted value of DIMD, and, pred_{mode1}, pred_{mode2} and predₚₗₐₙₐᵣ are predicted values respectively obtained by using mode1, mode2, and the planar modes.

(2) template based intra mode derivation and fusion (TIMD) prediction process:

TIMD is an intra prediction technology. In this technology, neighboring reconstructed samples are used as a template, and a sample adjacent to the template is used as a reference sample of the template. Each prediction mode in a most probable mode MPM list whose length is N is traversed to obtain predicted values of the N templates. Then, a sum of an absolute transformed difference (SATD) between a predicted value of the template sample and a reconstructed value of the template sample is calculated, and two modes mode1 and mode2 with a minimum template cost are selected. Costs corresponding to the two modes mode1 and mode2 are respectively costMode1 and costMode2. When costMode2<2*costMode1 is met, weighted fusion is performed on predicted values obtained by using mode1 and mode2 to obtain a final value for a current encoding block, where a weight is calculated based on template matching cost costMode1 and a costMode2. When costMode2<2*costMode1 is not met, the current block is predicted by using only the mode1.

The TIMD prediction flowchart is shown in FIG. 14.

Weights w1 and w2 of mode1 and mode2 in TIMD are calculated as follows:

$$w 1 = \frac{c o s t M o d e 2}{c o s t M o d e 1 + c o s t M o d e 2}$$

$$w 2 = \frac{c o s t M o d e 1}{c o s t M o d e 1 + c o s t M o d e 2}$$

The predicted value of TIMD is calculated as follows:

$$pred = w 1 \times pre {d}_{m ode 1} + w 2 \times pre {d}_{m ode 2}$$

in which, pred is a final predicted value of DIMD, pred_{mode1} and pred_{mode2} are predicted values respectively obtained by using mode1 and mode2

(3) Template-based multiple reference line intra prediction prediction process:

TMRL creates a multiple reference line candidate list based on multiple reference line MRL. The reference line candidate list is {1, 3, 5, 7, 12}, and a length of the list is 5. A number in the list represents an index of the reference line. In addition, a first row/column of samples adjacent to the current block are used as template of the current block. In addition, the TMRL extends the most probable mode MPM list, and a length of the extended MPM list is 10, where the planar mode is removed, the DC mode (if not included) is added after the five adjacent PU modes and the DIMD mode, and an angular mode whose angle difference is +−1 to +−4 is added. Then a TMRL combination list is created. There are 5×10=50 combinations in total in the list. Predicted values of the template of the current block for the 50 combinations, SAD between the 50 predicted values and a reconstructed value of the template of the current block is calculated, combinations corresponding to the first 20 minimum SADs are selected to form the final combination list of the TMRL, TMRL prediction is performed on the current block by using the 20 combinations, and a best combination is selected and transmitted to the decoding side by the encoding side.

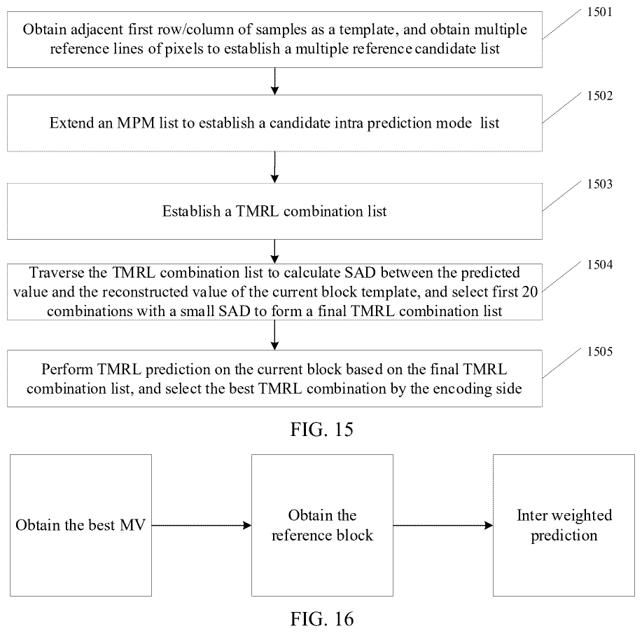

The TMRL prediction flowchart is shown in FIG. 15.

### (4) Inter Weighted Prediction Process:

In an inter prediction process, the motion compensation may be classified into a unidirectional motion compensation and a bidirectional motion compensation according to a slice type. A best matching block of the current block is determined according to best motion vector information from a reference picture in a forward reference list List0 or a backward reference list List1, and determines a prediction block of the current block according to the matching block. When unidirectional prediction is performed (that is, prediction is performed by using List 0 or List 1), the best matching block is determined from the List 0 reference picture or the List 1 reference picture, and weighted prediction is performed on the best matching blocks for the List 0 and the List 1 to obtain an inter prediction block of current block.

An existing inter weighted prediction technology mainly includes a default weighted prediction algorithm (Default WP), an explicit weighted prediction algorithm (Explicit WP), and a bidirectional weighted prediction algorithm with a CU level weight (BCW). The detailed description is as follows.

The default weighted prediction includes the following three cases according to the usage of the reference list:
Case (1): only the reference list List0 is used, and the predicted sample pbSamples[x][y] is calculated as follows:

$$pbSamples [ x ] [ y ] = Clip 3 ( 0 , ( 1 << bitDepth ) - 1 , ( predSamplesL 0 [ x ] [ y ] + offset 1 ) >> shift 1 ) \qquad ( 1 )$$

Case (2): only the reference list List1 is used, and the predicted sample pbSamples[x][y] is calculated as follows:

$$pbSamples [ x ] [ y ] = Clip 3 ( 0 , ( 1 << bitDepth ) - 1 , ( predSamplesL 1 [ x ] [ y ] + offset 1 ) >> shift 1 ) \qquad ( 2 )$$

Case (3): both the reference list List0 and the reference list List1 are used, and the predicted samples pbSamples[x][y] are calculated as follows:

$$pbSamples [ x ] [ y ] = Clip 3 ( 0 , ( 1 << bitDepth ) - 1 , ( predSamplesL 0 [ x ] [ y ] + predSamplesL 1 [ x ] [ y ] + offset 2 ) >> shift 2 ) \qquad ( 3 )$$

In which, predSamplesL0[x][y] and predSamplesL1[x][y] respectively represent a List 0 predicted value and a List 1 predicted value of a current CU, and x and y respectively represent a horizontal coordinate and a vertical coordinate of a sample in the CU. In which, shift1, shift2, offset1, and offset2 are unnecessary to be transmitted in the bitstream, and only need to be determined according to a bit depth bitDepth of an input sequence:

$$shift 1 = Max ( 2 , 14 - bitDepth )$$

$$shift 2 = Max ( 3 , 15 - bitDepth )$$

$$offset 1 = 1 << ( shift 1 - 1 )$$

$$offset 2 = 1 << ( shift 2 - 1 )$$

For explicit weighted prediction, weighting and correction need to be performed on predSamplesL0[x][y] and predSamplesL1[x][y] by using a specific weight and offset value in the motion compensation process.

Explicit weighted prediction includes the following three cases according to usage of the reference list.
Case (1): only the reference list List0 is used, the predicted sample pbSamples[x][y] is calculated as follows:

$$pbSamples [ x ] [ y ] = Clip 3 ( 0 , ( 1 ≪ bitDepth ) - 1 ,$$

$$( ( predSamplesL 0 [ x ] [ y ] * w 0 + 2 log 2 Wd - 1 ) ≫ log 2 Wd ) + o 0 )$$

Case (2): only the reference list List1 is used, the predicted sample pbSamples[x][y] is calculated as follows:

$$pbSamples [ x ] [ y ] = Clip 3 ( 0 , ( 1 ≪ bitDepth ) - 1 ,$$

$$( ( predSamplesL 1 [ x ] [ y ] * w 1 + 2 log 2 Wd - 1 ) ≫ log 2 Wd ) + o 1 )$$

Case (3): Both the reference list List0 and the reference list List1 are used, and the predicted sample pbSamples[x][y] is calculated as follows:

$$pbSamples [ x ] [ y ] = Clip 3 ( 0 , ( 1 ≪ bitDepth ) - 1 ,$$

$$( predSamplesL 0 [ x ] [ y ] * w 0 + predSamplesL 1 [ x ] [ y ] * w 1 + ( ( o 0 + o 1 + 1 ) ≪ log 2 Wd ) ) ≫ ( log 2 Wd + 1 ) )$$

in which, w0 and w1 are weights, o0 and o1 represent corresponding offsets, and values of the four parameters are determined by decoding a bitstream.

Bidirectional weighted prediction process with CU level weight (BCW):

For bidirectional predicted CU, VVC encoder or decoder may use BCW to determine a weighting coefficient for weighted prediction. Five candidate weight coefficients are preset in the BCW, and a weight coefficient of the BCW is determined according to a value of an index sequence number of the weight coefficient. A data processing process is as follows.

If bcwIdx, that is, an index of the BCW weight coefficient is 0 or ciip_flag is 1, the predicted sample pbSamples[x][y] is calculated as follows:

$$PbSamples [ x ] [ y ] = Clip 3 ( 0 , ( 1 ≪ bitDepth ) - 1 ,$$

$$( predSamplesL 0 [ x ] [ y ] + predSamplesL 1 [ x ] [ y ] + offset 2 ) ≫ shift 2 ) ;$$

if bcwIdx is not 0 and ciip_flag is 0, a forward prediction block weight w1 is bcwWLut[bcwIdx], where bcwWLut[k]={4,5,3,10,−2}; correspondingly, a forward prediction block weight w0 is 8-w1, and the predicted sample pbSamples[x][y] is calculated as follows:

$$pbSamples [ x ] [ y ] = Clip 3 ( 0 , ( 1 ≪ bitDepth ) - 1 ,$$

$$( w 0 * predSamplesL 0 [ x ] [ y ] + w 1 * predSamplesL 1 [ x ] [ y ] + offset 3 ) ≫ ( shift 1 + 3 ) )$$

$$where offset is 1 ≪ ( shift 1 + 2 ) .$$

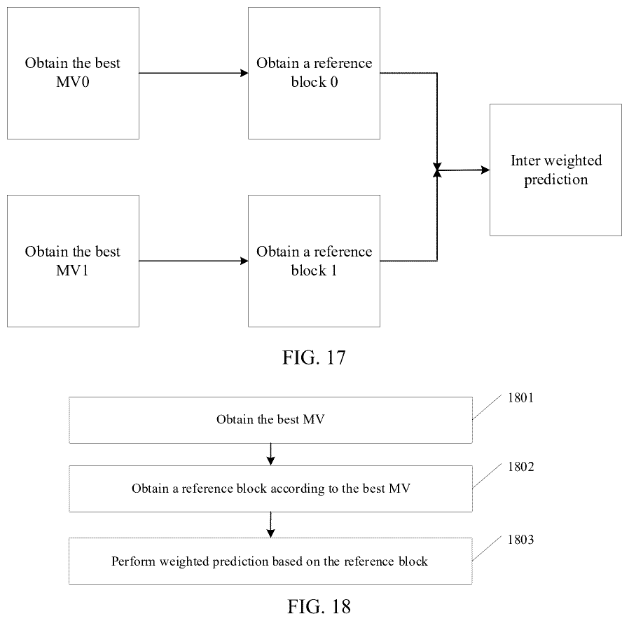

An inter unidirectional weighted prediction is shown in FIG. 16 and an inter bidirectional weighted prediction is shown in FIG. 17. A process of inter weighted prediction is shown in FIG. 18.

(1) In the conventional DIMD technology, HoG calculation is performed on a reconstructed sample in a neighboring template, to obtain an angular mode and a corresponding amplitude value of each sample, and the amplitude values are accumulated. Then, two modes corresponding to the two highest accumulated amplitude values in a histogram are used as a prediction mode, and finally, weighting is performed on predicted values obtained by using the two modes and the planar mode to obtain a final prediction value of the current block. Weights of the two modes are calculated based on the accumulated amplitude value, and the weight of the planar mode is fixed. This may lead to the following problems: the planar mode has a fixed weight, thus weakening adaptation of the weight fusion; and only modes corresponding to the two highest accumulated amplitude values are selected as the prediction mode, resulting in that reference information is limited.

(2) In the conventional TIMD technology, an MPM list is traversed by using the current block template and the reference sample of the template to predict the template, SATD between reconstruction values in the prediction template and the template is calculated. Two modes with a relatively small SATD are selected as prediction modes, and weighting is performed on prediction values obtained by the two prediction modes, and weights of the two modes are calculated based on the SATD. This may lead to the following problem: weighting is performed on only two modes with a relative small SATD, resulting in that the reference information is limited.

(3) In the conventional TMRL technology, an intra prediction mode list and a reference line candidate list are created, and a TMRL candidate list is obtained by combining the intra prediction mode list and the reference line candidate list. The template is predicted by using the current block template and a combination in the TMRL candidate list, SAD between the prediction template sample and the template reconstruction sample is calculated, combinations corresponding to the first 20 SADs are selected, and a best combination is selected and transmitted to the decoding side by the encoding side. This may lead to the following problems: additional bits need to be occupied to transmit the best combination, increasing the transmission burden. If the combination prediction results selected by using the SAD are similar, transmitting only the best combination results in that reference information is limited.

(4) The existing inter weighted prediction technology includes unidirectional prediction and bidirectional prediction. For unidirectional prediction, only the best mv is used to perform the motion compensation to obtain the prediction block. For bidirectional prediction, motion compensation is performed by using the best mv in each of the directions to obtain respective prediction blocks, and weighting is performed on the predicted blocks by using a fixed weight. This may lead to the following problems: for unidirectional and bidirectional prediction, only the best mv is used for motion compensation, resulting in that the reference information is limited; for bidirectional prediction, weighting is performed on the prediction block using a fixed weight, resulting in low adaptation of the prediction.

Reference information in the above conventional art is limited, resulting in degrading of adaptability and accuracy of the prediction.

Based on this, the following describes an exemplary application of embodiments of this application in an actual scenario.

A minMSE-based Fusion technology is put forward based on the above conventional technologies. Improvements on DIMD, TIMD, TMRL, and inter weighted prediction by using minMSE-based Fusion are described blow.

3.1 minMSE-Based Decoder Intra Prediction Fusion (minMSE-Based DIPF) Main Solution

The main solution of the minMSE-based DIPF technology is as follows.

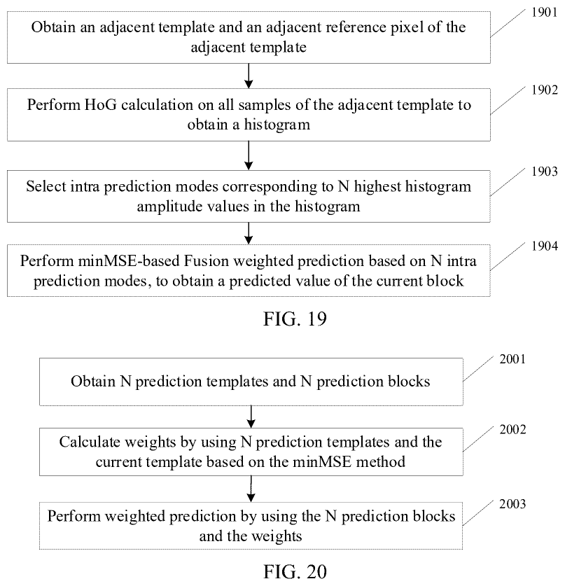

In this main solution, improvement of the minMSE-based DIPF technology presents in steps 1901, 1903, and 1904 in the DIMD prediction flowchart. A minMSE-based DIPF prediction flowchart is shown in FIG. 19. A neighboring template in FIG. 19 is an example of the foregoing current block template, a histogram amplitude value is the foregoing gradient amplitude, and an intra prediction mode in step 1903 is the foregoing angular mode. The encoder/decoder predicts the current block template according to the angular mode to obtain the prediction template. The predicted value of the current block in step 1904 is an example of the foregoing second predicted block of the current block.

A specific implementation procedure of step 1904 is shown in FIG. 20. A prediction block in FIG. 20 is the first prediction block described above.

### 3.1.1 Obtaining a Neighboring Template and Adjacent Reference Samples of and the Template

For the obtained neighboring template, a height is L2, a width is L1, and L1=L2=3 is set in DIMD. In fact, L1 and L2 may be determined adaptively based on a block size, or may be transmitted in a bitstream. A neighboring reference sample of the template is an upper left region, an upper region, an upper right region, a left region and a lower left region of the neighboring template. If the neighboring reference sample is available, the neighboring reference sample is obtained; if the neighboring reference sample is unavailable, the neighboring reference sample is not obtained. The reference sample of the template may also be a reference sample that is not adjacent to the template, for example, may be a second row of reference sample above the template. A schematic diagram of acquired neighboring templates and adjacent reference samples of the template is shown in FIG. 5. The template may have multiple shapes, and may be L-shaped. The L-shaped template may include an upper left template, an upper template, and a left template, or may include an upper left template, an upper template, an upper right template, a left upper, and a lower left template. The L-shaped template may include only the upper template or the left template, or the L-shaped template may include only the upper template and the left template.

### 3.1.2. Perform HoG Calculation on all Samples of the Neighboring Template to Obtain a Histogram.

FIG. 7 shows a template area, where T=3, a value of T may be adaptively selected based on a block size, or may be transmitted by using a bitstream. The DIMD separately calculates a horizontal gradient Gx and a vertical gradient Gy of a center sample of the template by using a 3×3 horizontal sober filter and vertical sober filter as shown by a right part of FIG. 7. Then, an angle of the corresponding sample may be calculated by using atan (Gy/Gx), and the angle is converted into one of 65 angle modes IPM in VVC. A sum of absolute values of Gx and Gy is used as a cumulative amplitude value of the angle.

The foregoing process is repeated for all samples in the template region center to obtain an intra angular mode histogram, as shown in FIG. 8.

3.1.3 Select the Intra Prediction Mode Corresponding to the N Highest Amplitude Values from the Histogram.

In the intra angular mode histogram, the first N intra prediction modes with a large amplitude value (that is, the selected candidate angular mode) are selected. Herein, the first N intra prediction modes with a relatively large amplitude value may be directly obtained. Alternatively, a threshold may be set; and only when the amplitude value is greater than or equal to the threshold, the intra prediction mode corresponding to the amplitude value may be used as the N candidate prediction modes. Alternatively, a magnitude difference threshold may be set; and only when a difference between adjacent magnitude values is less than or equal to the magnitude difference threshold, the intra prediction mode corresponding to the magnitude value is used as the N candidate prediction modes. The amplitude value is the gradient amplitude described above.

3.1.4. Perform minMSE-Based Fusion Weighted Prediction Based on N Intra Prediction Modes to Obtain a Predicted Value.

### 3.1.4.1 Obtain N Prediction Templates and N Prediction Blocks

Prediction is performed by using the N intra prediction modes and adjacent samples of the current block to obtain N prediction blocks predBlock of the current block, and the current template is predicted based on the N intra prediction modes and the adjacent samples of the template to obtain a prediction template refT.

### 3.1.4.2 Calculating Weights by Minimizing MSE by Using N Prediction Templates and the Current Block Template (i.e., the Template of the Current Block)

In an embodiment of the main solution of the minMSE-based DIPF technology, a weighted fusion weight is derived by minimizing the MSE between sample values of a prediction template refT obtained by using N prediction modes and a template refpredT to be predicted by using minMSE-based.

To derive the weight more flexible, in this main solution, an offset item is added when deriving the weighted fusion weight. The offset value Bias may be any constant in a picture sample range [0, (1<<bitDepth)−1]. In this main solution, Bias is set to 1<< (bitDepth−1).

Because BiasTerm is a constant, the BiasTerm needs to be extended into a matrix form in an actual calculation process. Specifically,

For each template refT of the N prediction templates:
for m=0, 1, . . . , M−1, where M is a quantity of samples in the template:

$${BiasTerm}_{m} = Bias$$

for each prediction block predBlock corresponding to each of the N prediction templates refT: forx=0, 1, . . . ,nTbW-1, y=0, . . . ,nTbH−1:

$${BiasTerm}_{x , y} = Bias .$$

After the offset item is added, the main solution needs to derive N+1 weights. For convenience of description, a variable P is used to record a quantity of weights, where P=N+1, and a prediction template sample/offset item sample is collectively referred to as a candidate reference sample refT_{N} and refT_{N+1}. Therefore, all reference quantities involved in the operation may be collectively represented as refTₚ. Similarly, the prediction block and the offset corresponding to the prediction template are collectively referred to as candidate prediction samples refBlockₚ, where p=0, 1, . . . , and P−1. Specific implementation is as follows.

Specifically, in a process of MSE minimization, an autocorrelation matrix of the first P candidate reference samples refT, a cross-correlation vector of the first P candidate reference samples refT and adjacent template samples curT of the current encoding block are inputted, to output a weight of a prediction block corresponding to each candidate reference item.

The MSE calculation formula is as follows:

$$MSE = \frac{1}{P} {\sum }_{p = 0}^{P - 1} {( {refpredT}_{p} - curT )}^{2} = \frac{1}{P} {\sum }_{p = 0}^{P - 1} {( {\sum }_{p = 0}^{P - 1} {w}_{p} * {refT}_{p} - curT )}^{2}$$

For convenience of representing the MSE calculation formula, E denotes mean squared error MSE, that is,

$$MSE = E [ {( {refpredT}_{p} - curT )}^{2} ] = E [ {( {\sum }_{p = 0}^{P - 1} {w}_{p} \cdot {refT}_{p} - curT )}^{2} ]$$

The weight wₚ of the prediction block corresponding to each candidate reference sample is derived by minimizing the MSE.

(1) partial derivative on wₚ is calculated, and let the partial derivative to be 0:

$$\frac{\partial MSE}{\partial {w}_{m}} = E [ 2 ( {\sum }_{p = 0}^{P - 1} {w}_{p} \cdot {refT}_{p} - curT ) \cdot {refT}_{p} ] , m = 0 , 1 , … , P - 1$$

$$E [ 2 ( {\sum }_{p = 0}^{P - 1} {w}_{p} \cdot {refT}_{p} - curT ) \cdot {refT}_{p} ] = 0$$

the following equation may be obtained according to the above two formulars:

$${\sum }_{p = 0}^{P - 1} {w}_{p} \cdot E ( {refT}_{p} \cdot {refT}_{p} ) = E ( curT \cdot {refT}_{p} )$$

(2) After the candidate reference sample regions refT₀, refT₁, . . . , refT_{P-1} are determined, the equation obtained in step (1) is expanded into a matrix form:

$$[ \begin{matrix}{\sum }_{i ∈ {refT}_{0}} ( refT [ i ] [ 0 ] \cdot refT [ i ] [ 0 ] ) & {\sum }_{i ∈ {refT}_{0}} ( refT [ i ] [ 1 ] \cdot refT [ i ] [ 0 ] ) & … & {\sum }_{i ∈ {refT}_{0}} ( refT [ i ] [ P - 1 ] \cdot refT [ i ] [ 0 ] ) \\ {\sum }_{i ∈ {refT}_{1}} ( refT [ i ] [ 0 ] \cdot refT [ i ] [ 1 ] ) & {\sum }_{i ∈ {refT}_{1}} ( refT [ i ] [ 1 ] \cdot refT [ i ] [ 1 ] ) & … & {\sum }_{i ∈ {refT}_{1}} ( refT [ i ] [ P - 1 ] \cdot refT [ i ] [ 1 ] ) \\ ⋮ & ⋮ & ⋱ & ⋮ \\ {\sum }_{i ∈ {refT}_{P - 1}} ( refT [ i ] [ 0 ] \cdot refT [ i ] [ P - 1 ] ) & {\sum }_{i ∈ {refT}_{P - 1}} ( refT [ i ] [ 1 ] \cdot refT [ i ] [ P - 1 ] ) & … & {\sum }_{i ∈ {refT}_{P - 1}} ( refT [ i ] [ P - 1 ] \cdot refT [ i ] [ P - 1 ] )\end{matrix} ] \cdot [ \begin{matrix}{w}_{0} \\ {w}_{1} \\ ⋮ \\ {w}_{P - 1}\end{matrix} ] = [ \begin{matrix}{\sum }_{i ∈ {refT}_{0}} ( curT \cdot refT [ i ] [ 0 ] ) \\ {\sum }_{i ∈ {refT}_{1}} ( curT \cdot refT [ i ] [ 1 ] ) \\ ⋮ \\ {\sum }_{i ∈ {refT}_{P - 1}} ( curT \cdot refT [ i ] [ P - 1 ] )\end{matrix} ]$$

(3) Since both the autocorrelation matrix and the cross-correlation vector in (2) are known, weights w0, . . . w_{P-1} of prediction samples corresponding to each candidate reference item may be calculated by solving the linear equation set in (2).

### 3.1.4.3 Performing Weighted Prediction Using N Prediction Blocks and Weights

A final prediction block (that is, the second prediction block) is calculated according to each candidate prediction block (that is, P first prediction blocks) and weighted fusion weights corresponding to the candidate prediction block. Specifically, a value of each candidate prediction block is multiplied by a corresponding weight to obtain a result, and the result is accumulated to obtain a current prediction block (that is, weighted prediction). The calculation formula is as follows:

For x=0, . . . ,nTbW−1 and y=0, . . . ,nTbH−1, the prediction value is calculated as follows:

$${predSamples}_{x , y} = {\sum }_{p = 0}^{P - 1} {w}_{p , x , y} * {predBlock}_{p , x , y}$$

Each predicted value predSamples_{x,y} is stored spatially, that is, a prediction block outputted by the minMSE-based DIPF.

3.2 Main solution of minMSE and Template-based Intra Prediction Fusion (minMSE and Template-based TIPF) Technology

The main solution of the TIPF technology is as follows.

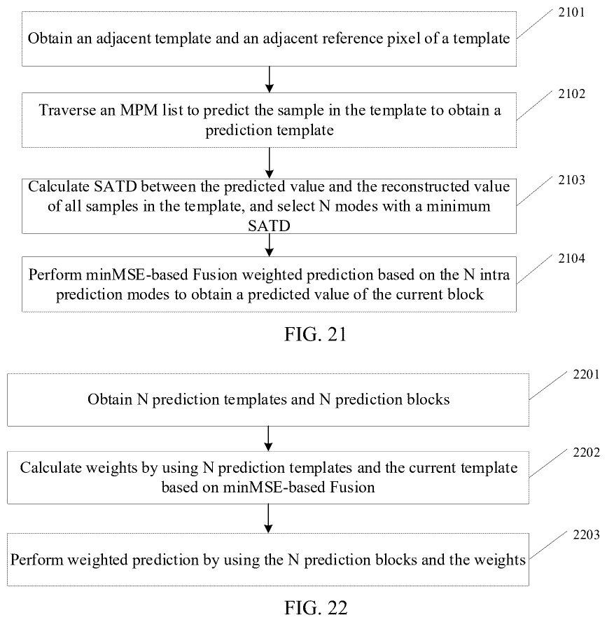

In this main solution, improvement of the TIPF technology presents in steps 1403 and 1404 in the TIMD prediction flowchart. A TIPF prediction flowchart is shown in FIG. 21, and specific implementation of step 2104 is shown in FIG. 22. The predicted value of all samples in the template described in step 2103 refers to a sample value of the prediction template of the template, the sample reconstruction value refers to a sample value of the template, and N modes refer to N types of intra prediction modes.

### 3.2.1 Obtaining a Neighboring Template and Adjacent Reference Samples of and the Template

For the obtained neighboring template, a height is L1, a width is L2, and L1=L2=3 is set in TIMD. In fact, L1 and L2 may be determined adaptively based on a block size, or may be transmitted in a bitstream. A neighboring reference sample of the template is an upper left region, an upper region, an upper right region, a left region and a lower left region of the neighboring template. If the neighboring reference sample is available, the neighboring reference sample is obtained; if the neighboring reference sample is unavailable, the neighboring reference sample is not obtained. The reference sample of the template may also be a reference sample that is not adjacent to the template, for example, may be a second row of reference sample above the template. A schematic diagram of acquired neighboring templates and adjacent reference samples of the template is shown in FIG. 5. The template may have multiple shapes, and may be L-shaped. The L-shaped template may include an upper left template, an upper template, and a left template, or may include an upper left template, an upper template, an upper right template, an upper left template, and a lower left template. The L-shaped template may include only the upper template or the left template, or the L-shaped template may include only the upper template and the left template.

### 3.2.2. Traversing the MPM List to Predict Samples in the Template to Obtain a Prediction Template.

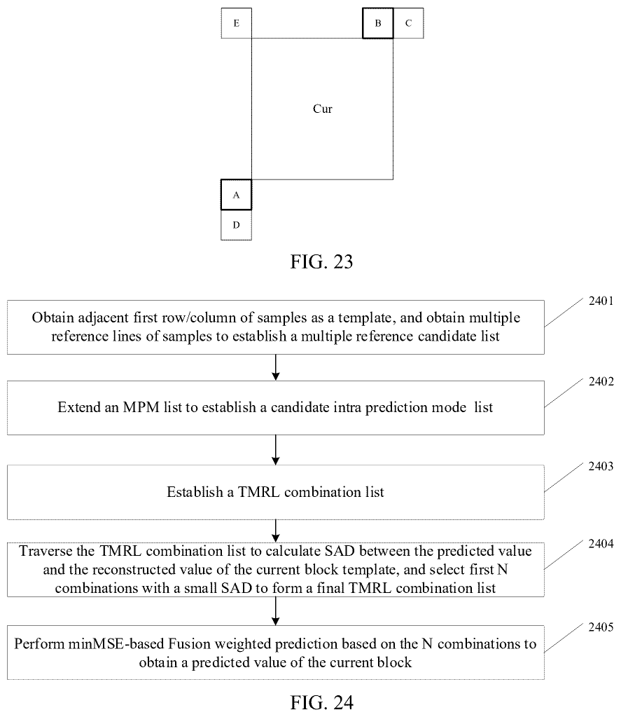

The VVC constructs a MPM list including 6 candidates by using two adjacent CUs (left adjacent block and upper adjacent block, as shown in A and B in FIG. 23).

The construction rule of the MPM list is as follows:

If the left CU and the upper CU are the same angle:

$$MPM list = \{ Planar , Left , Left - 1 , Left + 1 , Left - 2 , Left + 2 \}$$

if both the left CU and the upper CU are non-angle:

$$MPM list = \{ Planar , DC , V , H , V - 4 , V + 4 \} ;$$

if one of the left CU and the upper CU is an angle, the other of the two CUs is a non-angle, where max represents a maximum angle:

$$MPM list = \{ Planar , Max , Max - 1 , Max + 1 , Max - 2 , Max + 2 \} ;$$

if the left CU and the upper CU are different angles, where max represents a maximum angle:
if an absolute value of a difference between angles of the upper CU and the left CU is 1:

$$MPM list = \{ Planar , Left , Above , Min - 1 , Max + 1 , Min - 2 \} ;$$

if the absolute value of the difference is greater than or equal to 62:

$$MPM list = \{ Planar , Left , Above , Min + 1 , Max - 1 , Min + 2 \} ;$$

if the absolute value of the difference is equal to 2:

$$MPM list = \{ Planar , Left , Above , Min + 1 , Min - 1 , Max + 1 \} ;$$

if the absolute value of the difference is greater than 2 and less than 62,

$$MPM list = \{ Planar , Left , Above , Min - 1 , Min + 1 , Max - 1 \}$$

in this case, N<=6.

It should be noted that, the MPM list may be modified or extended. For example:
a DIMD derivation mode may be placed before or after the angular mode derived based on the adjacent CUs; or the Planar mode is deleted and a DC mode is placed after the angular mode derived based on the adjacent CUs; or some angular prediction modes may be added, for example, a relatively large angle and a relatively small angle in the list are extended, for example, Max+4 and Min−4.
   3.2.3. Calculating SATD Between Predicted Values of and Sample Reconstruction Values of all Samples in the Template, and Selecting N Modes with a Minimum SATD.

The calculation formula of SATD is as follows: SATD=Σ_{K}Σ_{K}|H×H|.

In which, K is a size of a residual matrix of the prediction template and the reconstruction template, and His a residual matrix subjected to the Hadamard transform.

Herein, a threshold may be set, for example, Ther, and only a prediction mode whose template matching cost is less than or equal to Ther is used as the candidate prediction mode.

3.2.4. Performing minMSE-Based Fusion Weighted Prediction Based on N Intra Prediction Modes to Obtain a Predicted Value of the Current Block.

### 3.2.4.1. Obtaining N Prediction Templates and N Prediction Blocks

Prediction is performed by using N intra prediction modes and adjacent samples of the current block to obtain N prediction blocks predBlock of the current block, and the current template is predicted based on the N intra prediction modes and adjacent samples of the template to obtain a prediction template refT.

In embodiments of the TIPF technology, a weighted fusion weight is derived by minimizing the MSE between samples of a prediction template refT obtained by using N prediction modes and a template refpredT to be predicted by using minMSE-based.

To derive the weight more flexible, in this main solution, an offset item is added when deriving the weighted fusion weight. The offset value Bias may be any constant in a picture sample range [0, (1<<bitDepth)−1]. In this main solution, Bias is set to 1<< (bitDepth-1).

Because BiasTerm is a constant, the BiasTerm needs to be extended into a matrix form in an actual calculation process. Specifically,

For each template refT of the N prediction templates:
for m=0, 1, . . . , M−1, where M is a quantity of samples in the template:

$${BiasTerm}_{m} = Bias$$

for each prediction block predBlock corresponding to each of the N prediction templates refT:
for x=0, 1, . . . ,nTbW−1, y=0, . . . ,nTbH−1:

$${BiasTerm}_{x , y} = Bias$$

After the offset item is added, the main solution needs to derive N+1 weights. For convenience of description, a variable P is used to record a quantity of weights, where P=N+1, and a prediction template sample/offset item sample is collectively referred to as a candidate reference sample refT_{N} and a refT_{N+1}. Therefore, all reference quantities involved in the operation may be collectively represented as refTₚ. Similarly, the prediction block and the offset corresponding to the prediction template are collectively referred to as candidate prediction samples refBlockₚ, where p=0, 1, . . . , and P−1. Specific implementation is as follows:

Specifically, in a process of MSE minimization, an autocorrelation matrix of the first P candidate reference samples refT, a cross-correlation vector of the first P candidate reference samples refT and adjacent template samples curT of the current encoding block are inputted, to output a weight of a prediction block corresponding to each candidate reference item.

The MSE calculation formula is as follows:

For a sample located at a same position of each candidate reference template, that is, for m=0, 1 . . . , M−1:

$$M S E = \frac{1}{P} {\sum }_{p = 0}^{P - 1} {( {refpredT}_{p} - c u r T )}^{2} = \frac{1}{P} {\sum }_{p = 0}^{P - 1} {( {\sum }_{p = 0}^{P - 1} {w}_{p} * {refT}_{p} - c u r T )}^{2} .$$

For convenience of representing the MSE calculation formula, E denotes mean squared error MSE, that is,

$$M S E = E [ {( refpred {T}_{p} - c u r T )}^{2} ] = E [ {( {\sum }_{p = 0}^{P - 1} {w}_{p} \cdot {refT}_{p} - c u r T )}^{2} ]$$

The weight wₚ of the prediction block corresponding to each candidate reference sample is derived by minimizing the MSE:

(1) partial derivative on wₚ is calculated, and let the partial derivative to be 0:

$$\frac{\partial M S E}{\partial {w}_{m}} = E [ 2 ( {\sum }_{p = 0}^{P - 1} {w}_{p} \cdot {refT}_{p} - c u rT ) \cdot {refT}_{p} ] , m = 0 , 1 , … , P - 1$$

$$E [ 2 ( {\sum }_{p = 0}^{P - 1} {w}_{p} \cdot {refT}_{p} - c u rT ) \cdot {refT}_{p} ] = 0$$

the following equation may be obtained according to the above two formulars:

$${\sum }_{p = 0}^{P - 1} {w}_{p} \cdot E ( {refT}_{p} \cdot {refT}_{p} ) = E ( c urT \cdot {refT}_{p} )$$

(2) After the candidate reference sample regions refT₀, refT₁, . . . , refT_{P-1} are determined, the equation obtained in step (1) is expanded into a matrix form:

$$[ \begin{matrix}\begin{matrix}{\sum }_{i ∈ {refT}_{0}} \\ \begin{matrix}( refT [ i ] [ 0 ] \cdot \\ refT [ i ] [ 0 ] )\end{matrix}\end{matrix} & \begin{matrix}{\sum }_{i ∈ {refT}_{0}} \\ \begin{matrix}( refT [ i ] [ 1 ] \cdot \\ refT [ i ] [ 0 ] )\end{matrix}\end{matrix} & … & \begin{matrix}{\sum }_{i ∈ {refT}_{0}} \\ \begin{matrix}( refT [ i ] [ P - 1 ] \cdot \\ refT [ i ] [ 0 ] )\end{matrix}\end{matrix} \\ \begin{matrix}{\sum }_{i ∈ {refT}_{1}} \\ \begin{matrix}( refT [ i ] [ 0 ] \cdot \\ refT [ i ] [ 1 ] )\end{matrix}\end{matrix} & \begin{matrix}{\sum }_{i ∈ {refT}_{1}} \\ \begin{matrix}( refT [ i ] [ 1 ] \cdot \\ refT [ i ] [ 1 ] )\end{matrix}\end{matrix} & … & \begin{matrix}{\sum }_{i ∈ {refT}_{1}} \\ \begin{matrix}( refT [ i ] [ P - 1 ] \cdot \\ refT [ i ] [ 1 ] )\end{matrix}\end{matrix} \\ ⋮ & ⋮ & ⋱ & ⋮ \\ \begin{matrix}{\sum }_{i ∈ {refT}_{P - 1}} \\ \begin{matrix}( refT [ i ] [ 0 ] \cdot \\ refT [ i ] [ P - 1 ] )\end{matrix}\end{matrix} & \begin{matrix}{\sum }_{i ∈ {refT}_{P - 1}} \\ \begin{matrix}( refT [ i ] [ 1 ] \cdot \\ refT [ i ] [ P - 1 ] )\end{matrix}\end{matrix} & … & \begin{matrix}{\sum }_{i ∈ {refT}_{P - 1}} \\ \begin{matrix}( refT [ i ] [ P - 1 ] \cdot \\ refT [ i ] [ P - 1 ] )\end{matrix}\end{matrix}\end{matrix} ] \cdot [ \begin{matrix}{w}_{0} \\ {w}_{1} \\ ⋮ \\ {w}_{P - 1}\end{matrix} ] = [ \begin{matrix}{\sum }_{i ∈ {refT}_{0}} ( curT \cdot refT [ i ] [ 0 ] ) \\ {\sum }_{i ∈ {refT}_{1}} ( curT \cdot refT [ i ] [ 1 ] ) \\ ⋮ \\ {\sum }_{i ∈ {refT}_{P - 1}} ( curT \cdot refT [ i ] [ P - 1 ] )\end{matrix} ]$$

(3) Since both the autocorrelation matrix and the cross-correlation vector in (2) are known, weights w0, . . . w_{P-1} of prediction samples corresponding to each candidate reference item may be calculated by solving the linear equation set in (2).

### 3.1.4.3 Performing Weighted Prediction Using N Prediction Blocks and Weights

A final prediction block is calculated according to each candidate prediction block and weighted fusion weights corresponding to the candidate prediction block. Specifically, a value of each candidate prediction block is multiplied by a corresponding weight to obtain a result, and the result is accumulated to obtain a current prediction block (that is, weighted prediction). The calculation formula is as follows:

For x=0, . . . ,nTbW−1 and y=0, . . . ,nTbH−1, the prediction value is calculated as follows:

$${predSamples}_{x , y} = {\sum }_{p = 0}^{P - 1} {w}_{p , x , y} * p r e d B l o c {k}_{p , x , y}$$

Each predicted value predSamples_{x,y} is stored spatially, that is, a prediction block outputted by the minMSE-based TIPF.

3.3. Main Solution of minMSE and Template-Based Multiple Reference Line Intra Prediction Fusion (minMSE-Based TMRLF) Technology

The main solution of the TMRLF technology is as follows.

In this main solution, improvement of the TMRLF technology presents in steps 1504 and 1505 in the TMRL prediction flowchart. A TMRLF prediction flowchart is shown in FIG. 24. In which, the intra prediction mode list is an example of the foregoing mode list, the multi-reference candidate list is a reference line list of the foregoing current block template, and the TMRL combination list is an example of the foregoing combination list. Specific implementation of step 2405 is shown in FIG. 22.

### 3.3.1. Acquiring Neighboring First Row/Column of Samples as a Template and Simultaneously Acquiring Multiple Reference Lines of Samples to Establish a Multi-Reference Candidate List.

A schematic diagram of the acquired current block template and multiple reference lines is shown in FIG. 10B, where in TMRL, the current block template is a first row and a first column of samples adjacent to the current block. In addition, a template of the current block may also be a first M rows and first M columns of samples adjacent to the current block. The template may have multiple shapes, and may be L-shaped. The L-shaped template may include an upper left template, an upper template, and a left template, or may include an upper left template, an upper template, an upper right template, a left template, and a lower left template. The L-shaped template may include only the upper template or the left template, or the L-shaped template may include only the upper template and the left template.

### 3.3.2. Extending the MPM List to Establish the Intra Prediction Mode Candidate List

The TMRL extends the length of the MPM list to 10. The extended MPM list differs from the existing MPM list in that: the planar mode is excluded from the proposed intra prediction mode candidate list; the DC mode (if not included) is added after the modes of the five adjacent PUs and the DIMD mode; and an angular mode whose angle difference is +−1 to +−4 is added.

In addition, the extended MPM list may be further extended or modified to an intra prediction mode candidate list having a length M. For example,
the DIMD derivation mode may be placed before or after the angular mode derived based on the adjacent CUs. Alternatively, the Planar mode is reserved, and then the DC mode is placed after the angular mode derived based on the adjacent CUs.

### 3.3.3. Create a TMRL Combination List.

For the current block, extended reference lines used by the TMRL include 5 reference lines indicated by {1, 3, 5, 7, 12}, and an extended MPM list includes 10 prediction modes. Therefore, a TMRL combination list may be established, and the combination list includes 5×10=50 combinations in total.

In addition, the TMRLF may further extend or modify the candidate reference line list to a candidate reference line list whose length is N. When N=6, the candidate reference line list may be {1,4,5,7,10,12}, or may be {1,2,3,7,10,11}. In this case, there are a total of N×M combinations in the combination list, where M is a length of the intra prediction mode candidate list.

3.3.4. Traversing the TMRL Combination List to Calculate SAD Between the Predicted Value and the Reconstructed Value of the Current Block Template, and Select the First N Combinations with a Small SAD to Form the Final TMRL Combination List.

The SAD calculation formula is as follows:

$$SAD = {\sum }_{x = 0}^{W - 1} {\sum }_{y = 0}^{H - 1} \vert {rec}_{x , y} - p r {e}_{x , y} \vert$$

in which, W is a width of the template, H is a height of the template, rec is the reconstructed sample value of the template, and pre is the predicted sample value of the template.

Herein, a threshold may be set, for example, Ther, and only a prediction mode whose template matching cost is less than or equal to Ther is used as the candidate prediction mode.

3.3.5. Performing minMSE-Based Fusion Weighted Prediction Based on N Combinations to Obtain a Predicted Value of the Current Block.

### 3.3.5.1. Obtaining N Prediction Templates and N Prediction Blocks

Prediction is performed by using the N intra prediction modes and adjacent samples of the current block to obtain N prediction blocks predBlock of the current block, and the current template is predicted based on the N intra prediction modes and the adjacent samples of the template to obtain a prediction template refT.

3.3.5.2. Calculating a Weight According to minMSE-Based Fusion by Using the N Prediction Templates and the Current Block Template.

In an embodiment of the main solution of the TIPF technology, a weighted fusion weight is derived by minimizing the MSE between sample values of a prediction template refT obtained by using N prediction modes and a template refpredT to be predicted by using minMSE-based.

To derive the weight more flexible, in this main solution, an offset item is added when deriving the weighted fusion weight. The offset value Bias may be any constant in a picture sample range [0, (1<<bitDepth)−1]. In this main solution, Bias is set to 1<< (bitDepth-1).

Because BiasTerm is a constant, the BiasTerm needs to be extended into a matrix form in an actual calculation process. Specifically, For each template refT of the N prediction templates:
for m=0, 1, . . . , M−1, where M is a quantity of samples in the template:

$${BiasTerm}_{m} = Bias$$

for each prediction block predBlock corresponding to each of the N prediction templates refT:
for x=0, 1, . . . ,nTbW−1, y=0, . . . , nTbH−1:

$$BiasTer {m}_{x , y} = Bias$$

After the offset item is added, the main solution needs to derive N+1 weights. For convenience of description, a variable P is used to record a quantity of weights, where P=N+1, and a prediction template sample/offset item sample is collectively referred to as a candidate reference sample refT_{N} and refT_{N+1}. Therefore, all reference quantities involved in the operation may be collectively represented as refTₚ. Similarly, the prediction block and the offset corresponding to the prediction template are collectively referred to as candidate prediction samples refBlockₚ, where p=0, 1, . . . , and P−1. Specific implementation is as follows.

Specifically, in a process of MSE minimization, an autocorrelation matrix of the first P candidate reference samples refT, a cross-correlation vector of the first P candidate reference samples refT and adjacent template samples curT of the current encoding block are inputted, to output a weight of a prediction block corresponding to each candidate reference item.

The MSE calculation formula is as follows:
For a sample located at a same position of each candidate reference template, that is, for m=0, 1, . . . , M−1:

$$M S E = \frac{1}{P} {\sum }_{p = 0}^{P - 1} {( refpred {T}_{p} - c u r T )}^{2} = \frac{1}{P} {\sum }_{p = 0}^{P - 1} {( {\sum }_{p = 0}^{P - 1} {w}_{p} * {refT}_{p} - c u r T )}^{2}$$

For convenience of representing the MSE calculation formula, E denotes mean squared error MSE, that is,

$$MSE = E [ {( {refpredT}_{p} - curT )}^{2} ] = E [ {( {\sum }_{p = 0}^{P - 1} {w}_{p} \cdot {refT}_{p} - curT )}^{2} ]$$

The weight wₚ of the prediction block corresponding to each candidate reference sample is derived by minimizing the MSE.

(1) partial derivative on wₚ is calculated, and let the partial derivative to be 0::

$$\frac{\partial MSE}{\partial {w}_{m}} = E [ 2 ( {\sum }_{p = 0}^{P - 1} {w}_{p} \cdot {refT}_{p} - curT ) \cdot {refT}_{p} ] , m = 0 , 1 , … , P - 1$$

$$E [ 2 ( {\sum }_{p = 0}^{P - 1} {w}_{p} \cdot {refT}_{p} - curT ) \cdot {refT}_{p} ] = 0$$

the following equation may be obtained according to the above two formulars:

$${\sum }_{p = 0}^{P - 1} {w}_{p} \cdot E ( {refT}_{p} \cdot {refT}_{p} ) = E ( curT \cdot {refT}_{p} )$$

(2) After the candidate reference sample regions refT₀, refT₁, . . . , refT_{P-1} are determined, the equation obtained in step (1) is expanded into a matrix form:

$$[ \begin{matrix}{\sum }_{i ∈ {refT}_{0}} ( refT [ i ] [ 0 ] \cdot refT [ i ] [ 0 ] ) & {\sum }_{i ∈ {refT}_{0}} ( refT [ i ] [ 1 ] \cdot refT [ i ] [ 0 ] ) & … & {\sum }_{i ∈ {refT}_{0}} ( refT [ i ] [ P - 1 ] \cdot refT [ i ] [ 0 ] ) \\ {\sum }_{i ∈ {refT}_{1}} ( refT [ i ] [ 0 ] \cdot refT [ i ] [ 1 ] ) & {\sum }_{i ∈ {refT}_{1}} ( refT [ i ] [ 1 ] \cdot refT [ i ] [ 1 ] ) & … & {\sum }_{i ∈ {refT}_{1}} ( refT [ i ] [ P - 1 ] \cdot refT [ i ] [ 1 ] ) \\ ⋮ & ⋮ & ⋱ & ⋮ \\ {\sum }_{i ∈ {refT}_{P - 1}} ( refT [ i ] [ 0 ] \cdot refT [ i ] [ P - 1 ] ) & {\sum }_{i ∈ {refT}_{P - 1}} ( refT [ i ] [ 1 ] \cdot refT [ i ] [ P - 1 ] ) & … & {\sum }_{i ∈ {refT}_{P - 1}} ( refT [ i ] [ P - 1 ] \cdot refT [ i ] [ P - 1 ] )\end{matrix} ] \cdot [ \begin{matrix}{w}_{0} \\ {w}_{1} \\ ⋮ \\ {w}_{P - 1}\end{matrix} ] = [ \begin{matrix}{\sum }_{i ∈ {refT}_{0}} ( curT \cdot refT [ i ] [ 0 ] ) \\ {\sum }_{i ∈ {refT}_{1}} ( curT \cdot refT [ i ] [ 1 ] ) \\ ⋮ \\ {\sum }_{i ∈ {refT}_{P - 1}} ( curT \cdot refT [ i ] [ P - 1 ] )\end{matrix} ]$$

(3) Since both the autocorrelation matrix and the cross-correlation vector in (2) are known, weights w0, . . . w_{P-1} of prediction samples corresponding to each candidate reference item may be calculated by solving the linear equation set in (2).

### 3.3.5.3 Performing Weighted Prediction Using N Prediction Blocks and Weights

A final prediction block is calculated according to each candidate prediction block and weighted fusion weights corresponding to the candidate prediction block. Specifically, a value of each candidate prediction block is multiplied by a corresponding weight to obtain a result, and the result is accumulated to obtain a current prediction block (that is, weighted prediction). The calculation formula is as follows:

For x=0, . . . ,nTbW−1 and y=0, . . . ,nTbH−1, the prediction value is calculated as follows:

$${predSamples}_{x , y} = {\sum }_{p = 0}^{P - 1} {w}_{p , x , y} * {predBlock}_{p , x , y}$$

Each predicted value predSamples_{x,y} is stored spatially, that is, a prediction block outputted by the TMRLF.

3.4. Main Solution of minMSE and Template-Based Inter Weighted Prediction Fusion (minMSE and Template-Based IWPF) Technology

The main solution of the IWPF technology is as follows.

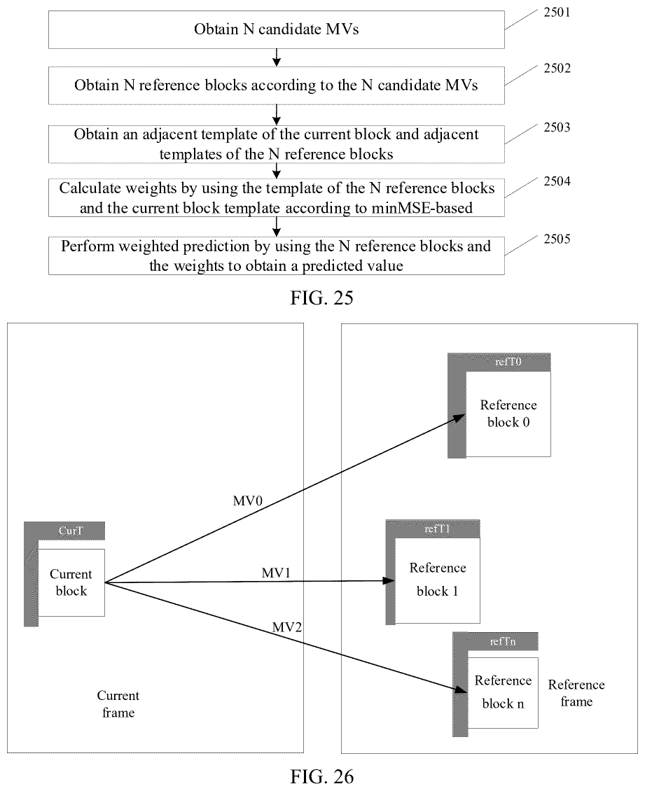

In this main solution, improvement of the IWPF technology presents in steps 1801 to 1803 in the intra weighted prediction flowchart. An IWPF prediction flowchart is shown in FIG. 25, where the adjacent template of the reference block in FIG. 25 is an example of the prediction template described above.

### 3.4.1 Obtaining N Candidate MVs

During the inter prediction process, a MV candidate list is created, including the Merge candidate list and the AMVP candidate list. In this main solution, the first N candidate MVs are obtained. It should be noted that the candidate MV herein may be a MV before or after template matching TM refinement, or may be a MV before or after DMVR and Multipass DMVR refinement.

3.4.2 Obtaining N reference blocks according to N candidate MVs

Motion compensation is performed according to the N candidate MVs, to obtain N reference blocks from the reference frame, indicating as refBlock.

3.4.3 Obtaining the adjacent template of the current block and the adjacent templates of N reference blocks

The adjacent template curT of the current block and the adjacent template refT of the N reference blocks are obtained. The template size is TemplateSizeW and TemplateSizeH. The template may have multiple shapes, and may be L-shaped. The L-shaped template may include an upper left template, an upper template, and a left template, or may include an upper left template, an upper template, an upper right template, a left template, and a lower left template. The L-shaped template may include only the upper template or the left template, or the L-shaped template may include only the upper template and the left template. A schematic diagram is shown in FIG. 26.

3.4.4 Calculating Weights According to minMSE-Based by Using the Template of N Reference Blocks and the Current Block Template

In an embodiment of the main solution of the IWPF technology, a weighted fusion weight is derived by minimizing the MSE between sample values of a template refT of N reference blocks and a template refpredT to be predicted by using minMSE-based.

To derive the weight more flexible, in this main solution, an offset item is added when deriving the weighted fusion weight. The offset value Bias may be any constant in a picture sample range [0, (1<<bitDepth)−1]. In this main solution, Bias is set to 1<< (bitDepth−1).

Because BiasTerm is a constant, the BiasTerm needs to be extended into a matrix form in an actual calculation process. Specifically,

For each template refT of the N prediction templates:
for m=0, 1, . . . , M−1, where M is a quantity of samples in the template:
BiasTermₘ=Bias for each prediction block predBlock corresponding to each of the N prediction templates refT: for x=0, 1, . . . ,nTbW−1, y=0, . . . ,nTbH−1:

$${BiasTerm}_{x , y} = Bias .$$

After the offset item is added, the main solution needs to derive N+1 weighted weights. For convenience of description, a variable P is used to record a quantity of weights, where P=N+1, and a reference template sample/offset item sample is collectively referred to as a candidate reference sample refT_{N} and refT_{N+1}. Therefore, all reference quantities involved in the operation may be collectively represented as refTₚ. Similarly, the reference block and the offset corresponding to the reference template are collectively referred to as candidate prediction samples refBlockₚ, where p=0, 1, . . . , and P−1. Specific implementation is as follows.

Specifically, in a process of MSE minimization, an autocorrelation matrix of the first P candidate reference samples refT, a cross-correlation vector of the first P candidate reference samples refT and adjacent template samples curT of the current encoding block are inputted, to output a weight of a prediction block corresponding to each candidate reference item.

The MSE calculation formula is as follows:
For a sample located at a same position of each candidate reference template, that is, for m=0, 1 . . . , M−1:

$$MSE = \frac{1}{P} {\sum }_{p = 0}^{P - 1} {( {refpredT}_{p} - curT )}^{2} = \frac{1}{P} {\sum }_{p = 0}^{P - 1} {( {\sum }_{p = 0}^{P - 1} {w}_{p} * {refT}_{p} - curT )}^{2}$$

For convenience of representing the MSE calculation formula, E denotes mean squared error MSE, that is,

$$MSE = E [ {( {refpredT}_{p} - curT )}^{2} ] = E [ {( {\sum }_{p = 0}^{P - 1} {w}_{p} \cdot {refT}_{p} - curT )}^{2} ]$$

The weight wₚ of the prediction block corresponding to each candidate reference sample is derived by minimizing the MSE:

(1) partial derivative on wₚ is calculated, and let the partial derivative to be 0:

$$\frac{\partial MSE}{\partial {w}_{m}} = E [ 2 ( {\sum }_{p = 0}^{P - 1} {w}_{p} \cdot {refT}_{p} - curT ) \cdot {refT}_{p} ] , m = 0 , 1 , … , P - 1$$

$$E [ 2 ( {\sum }_{p = 0}^{P - 1} {w}_{p} \cdot {refT}_{p} - curT ) \cdot {refT}_{p} ] = 0$$

the following equation may be obtained according to the above two formulars:

$${\sum }_{p = 0}^{P - 1} {w}_{p} \cdot E ( {refT}_{p} \cdot {refT}_{p} ) = E ( curT \cdot {refT}_{p} )$$

(2) After the candidate reference sample regions refT₀, refT₁, . . . , refT_{P-1} are determined the equation obtained in step (1) is expanded into a matrix form

$$[ \begin{matrix}{\sum }_{i ∈ {refT}_{0}} ( refT [ i ] [ 0 ] \cdot refT [ i ] [ 0 ] ) & {\sum }_{i ∈ {refT}_{0}} ( refT [ i ] [ 1 ] \cdot refT [ i ] [ 0 ] ) & … & {\sum }_{i ∈ {refT}_{0}} ( refT [ i ] [ P - 1 ] \cdot refT [ i ] [ 0 ] ) \\ {\sum }_{i ∈ {refT}_{1}} ( refT [ i ] [ 0 ] \cdot refT [ i ] [ 1 ] ) & {\sum }_{i ∈ {refT}_{1}} ( refT [ i ] [ 1 ] \cdot refT [ i ] [ 1 ] ) & … & {\sum }_{i ∈ {refT}_{1}} ( refT [ i ] [ P - 1 ] \cdot refT [ i ] [ 1 ] ) \\ ⋮ & ⋮ & ⋱ & ⋮ \\ {\sum }_{i ∈ {refT}_{P - 1}} ( refT [ i ] [ 0 ] \cdot refT [ i ] [ P - 1 ] ) & {\sum }_{i ∈ {refT}_{P - 1}} ( refT [ i ] [ 1 ] \cdot refT [ i ] [ P - 1 ] ) & … & {\sum }_{i ∈ {refT}_{P - 1}} ( refT [ i ] [ P - 1 ] \cdot refT [ i ] [ P - 1 ] )\end{matrix} ] \cdot [ \begin{matrix}{w}_{0} \\ {w}_{1} \\ ⋮ \\ {w}_{P - 1}\end{matrix} ] = [ \begin{matrix}{\sum }_{i ∈ {refT}_{0}} ( curT \cdot refT [ i ] [ 0 ] ) \\ {\sum }_{i ∈ {refT}_{1}} ( curT \cdot refT [ i ] [ 1 ] ) \\ ⋮ \\ {\sum }_{i ∈ {refT}_{P - 1}} ( curT \cdot refT [ i ] [ P - 1 ] )\end{matrix} ]$$

(3) Since both the autocorrelation matrix and the cross-correlation vector in (2) are known, weights w0, . . . w_{P-1} of reference samples corresponding to each candidate reference item may be calculated by solving the linear equation set in (2).

### 3.4.5 Performing Weighted Prediction Based on N Reference Blocks and Weights to Obtain a Predicted Value

A final prediction block is calculated according to each candidate reference block and weighted fusion weights corresponding to the candidate reference block. Specifically, a value of each candidate prediction block is multiplied by a corresponding weight to obtain a result, and the result is accumulated to obtain a current prediction block (that is, weighted prediction). The calculation formula is as follows:

For x=0, . . . ,nTbW−1 and y=0, . . . ,nTbH−1, the prediction value is calculated as follows:

$${predSamples}_{x , y} = {\sum }_{p = 0}^{P - 1} {w}_{p , x , y} * {predBlock}_{p , x , y}$$

Each predicted value predSamples_{x,y} is stored spatially, that is, a prediction block outputted by the IWPF.

This master solution proposes DIPF, TIPF, TMRLF, and IWPF techniques based on MSE minimization respectively for the existing DIMD, TIMD, TMRL, and inter weighted prediction. The DIPF, TIPF, and TMRLF can improve intra prediction accuracy, and the IWPF can improve inter prediction accuracy.

For the DIPF, a histogram is obtained by performing HoG calculation on neighboring template samples, and different histogram strips correspond to different intra prediction modes. Then, prediction is performed on the template and the current block by using the intra prediction modes corresponding to first N highest histogram strips, to obtain N prediction templates and N prediction blocks; weights in different prediction modes are obtained by minimizing MSE between the N prediction templates and the current template, and weighted prediction is performed by using the N prediction blocks and the weights to obtain a final prediction block. In this method, modes corresponding to different histogram strips is fully considered, rather than modes corresponding to only the first two highest histogram strips are considered. On the other hand, weights are adaptively allocated to the prediction block by using different prediction template information, and thus different importance of different prediction block information to the prediction of the current block is fully considered. In this method, a test is conducted on ECM 7.0 at All Intra condition at an interval of 48 frames, BD-rate changes of −0.xx %, −0.xx %, and −0.xx % can be obtained on Y, Cb, and Cr (that is, the average bit rate changes under the same psnr).

For the TIPF, the intra prediction modes in the MPM list are traversed by using the neighboring template samples and reference samples of the template to obtain N prediction templates, and a the intra prediction modes in the MPM list are traversed by using neighboring samples of the current block to obtain N prediction templates. Then, weights in different prediction modes are obtained by minimizing MSE between the N prediction templates and the current template, and weighted prediction is performed by using the N prediction templates and the weights to obtain a final prediction block. In this method, weights are adaptively allocated to the prediction blocks by using different prediction template information, and thus different importance of different prediction block information to the prediction of the current block is fully considered. In this method, a test is conducted on ECM 7.0 at All Intra condition at an interval of 48 frames, BD-rate changes of −0.xx %, −0.xx %, and −0.xx % can be obtained on Y, Cb, and Cr (that is, the average bit rate changes under the same psnr).

For the TMRLF, a reference line candidate list and an intra prediction mode candidate list are established, and a TMRL combination list is obtained by combining the reference line candidate list and the intra prediction mode candidate list. The TMRL combination list is traversed by using samples of adjacent templates of the current block to obtain N prediction templates with a small SAD, and the current block is predicted by using N prediction modes in the N combinations to obtain N prediction blocks. Then, weights in different prediction modes are obtained by minimizing MSE between the N prediction templates and the current template, and weighted prediction is performed by using the N prediction blocks and weights to obtain a final prediction block. In this method, weights are adaptively allocated to the prediction blocks by using different prediction template information, and thus different importance of different prediction block information to the prediction of the current block is fully considered. In this method, a test is conducted on ECM 7.0 at All Intra condition at an interval of 48 frames, BD-rate changes of −0.xx %, −0.xx %, and −0.xx % can be obtained on Y, Cb, and Cr (that is, the average bit rate changes under the same psnr).

For the IWPF, the N candidate MVs are obtained to perform motion compensation, to obtain the N candidate reference blocks, and the neighboring template of the current block and the neighboring templates of the N candidate reference blocks are obtained. Then, weights of the N reference blocks are obtained by minimizing MSE between the template of the N reference blocks and the current template, and weighted prediction is performed by using the N reference blocks and the weights to obtain a final prediction block. In this method, reference block information for different motion information is fully considered, weights are adaptively allocated to the reference blocks by using different reference template information, and thus different importance of different reference block information to the prediction of the current block is fully considered. In this method, a test is conducted on ECM 7.0 at Random Access (RA), BD-rate changes of −0.xx %, −0.xx %, and −0.xx % can be obtained on Y, Cb, and Cr (that is, the average bit rate changes under the same psnr).

In this main solution, according to the DIPF, TIPF, TMRLF, and IWPF technologies based on minimizing MSE, weights are adaptively allocated to reference blocks by minimizing MSE by using different reference block template information.

(1) The DIPF fully utilizes prediction block information corresponding to different prediction templates in different intra prediction modes, and minimizes MSE between the prediction template and the current template to calculate weights of the prediction block corresponding to different prediction templates.

(2) The TIPF fully utilizes prediction block information corresponding to different prediction templates in different intra prediction modes, and minimizes MSE between the prediction template and the current template to calculate weights of the prediction block corresponding to different prediction templates.

(3) The TMRLF fully utilizes prediction block information corresponding to different prediction templates under different intra prediction modes and different reference lines, and minimizes MSE between the prediction template and the current template to calculate weights of the prediction block corresponding to different prediction templates.

(4) The IWPF fully utilizes reference block information corresponding to different reference templates under different MV information, and minimizes MSE between the reference block template and the current block template to calculate weights of the reference block corresponding to different reference block templates.

Extension solution 1: In the foregoing four technologies, the weight is calculated by minimizing the MSE. In the extensions solution 1, the weight may be calculated as follows. An offset item may not be added, or a prediction value obtained in another mode, such as a Planar mode or a DC mode, is added as an offset item, where mode duplicate checking needs to be performed. Alternatively, a non-linear term may be added, for example, a square of a template sample with a minimum template matching cost is added.

For the TIPF, the SATD selection strategy in the TIPF is changed. For example, the first N prediction modes may be selected by using the SAD function, the MSE function, and the SSE function.

For the SAD selection strategy in the TMRLF, another function may be used to select the first N prediction modes, for example, an SATD function, an MSE function, and an SSE function.

Extension solution 3: In inter prediction, for bidirectional weighted prediction, a prediction block in each direction may be obtained based on minMSE weighting.

Extension solution 4: The min-MSE-based Fusion method is applied to another technology that requires weighted fusion, to improve adaptability. The existing technologies including weighted fusion include CIIP, Chroma Fusion, OBMC, SGPM, GPM, MHP, and so on.

For example, for the CIIP technology, a weight of a prediction block obtained by an intra mode and a weight of a prediction block obtained by an inter mode for the current block are fixed. In this case, neighboring samples of the current encoding block may be used as a template, the template is predicted by using a current intra prediction mode to obtain an intra prediction template, a neighboring template of the inter reference block is obtained by using MV information, and weights of the intra prediction block and the inter prediction block are calculated by minimizing the MSE between the intra prediction template, the neighboring template of the inter reference block and the current block template.

For example, for an inter MHP technology, neighboring samples of the current block are used as a template, and a prediction value of the current template is obtained by using different inter prediction modes, which is referred to as a prediction template. Weights of the prediction blocks obtained in different inter prediction modes are calculated based on the prediction template and the current template, and then weighting is performed on the prediction blocks.

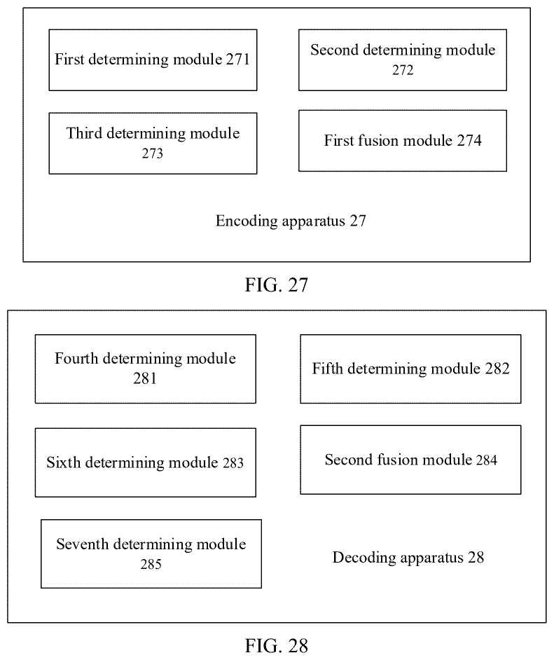

Based on the foregoing embodiment, an embodiment of this application provides an encoding apparatus, applied to an encoder. FIG. 27 is a schematic structural diagram of an encoding apparatus according to an embodiment of this application. As shown in FIG. 27, the encode apparatus 27 includes: a first determining module 271, a second determining module 272, a third determining module 273 and a first fusion module 274.

The first determining module 271 is configured to determine a template of a current block and one or more prediction templates of the template of the current block.

The second determining module 272 is configured to determine a weight of the one or more prediction templates according to the template of the current block and the one or more prediction templates.

The third determining module 273 is configured to determine one or more first prediction blocks of the current block according to a prediction parameter of the current block.

The first fusion module 274 is configured to fuse the one or more first prediction blocks by using weights of the one or more prediction templates, to obtain a second prediction block of the current block.

In some embodiments, the third determining module 273 is configured to determine the first prediction block of the current block according to an intra prediction mode indicated by the prediction parameter.

In some embodiments, the third determining module 273 is configured to determine the first prediction block of the current block according to a motion parameter or BV of the current block indicated by the prediction parameter.

In some embodiments, the motion parameter includes at least one of the following parameters: MV, or a reference image index.

In some embodiments, the prediction parameter of the current block is the same as a prediction parameter of the template of the current block.

In some embodiments, the first determining module 271 is configured to perform HoG calculation on a sample of the template of the current block to obtain a gradient direction and a gradient amplitude of the sample; determining an angular mode according to the gradient direction and the gradient amplitude; and predict the template of the current block according to the angular mode, to obtain the prediction template.

In some embodiments, the first determining module 271 is configured to convert the gradient direction into a predefined candidate angular mode; and determine the angular mode from the candidate angular mode according to the gradient amplitude.

In some embodiments, the first determining module 271 is configured to: obtain N angular modes according to candidate angular modes corresponding to N maximum gradient amplitudes; and/or obtain one or more angular modes according to a candidate angular mode corresponding to a gradient amplitude greater than or equal to a first threshold; and/or obtain one or more angular modes according to a candidate angular mode corresponding to a second gradient amplitude, where a difference between the second gradient amplitude and the at least one first gradient amplitude is less than or equal to a second threshold.

In some embodiments, a size of the at least one first gradient amplitude is adjacent to the second gradient amplitude.

In some embodiments, the first determining module 271 is configured to predict the template of the current block according to the candidate prediction mode in the mode list, to obtain the candidate prediction template; and obtain the prediction template according to a sample value error between the candidate prediction template and the current block template.

In some embodiments, the first determining module 271 is configured to: obtain N prediction templates according to candidate prediction templates corresponding to N minimum sample value errors; or obtain the one or more prediction templates according to candidate prediction templates corresponding to a sample value error less than or equal to a third threshold.

In some embodiments, a type of the sample value error is at least one of: SATD, SAD, MAD, MAE, NCC, MSE, SSE.

In some embodiments, the candidate prediction mode in the mode list includes at least one of the following:
the angular mode obtained by performing the above steps;
a prediction mode in an MPM list;
a prediction mode in an MPM list in which a Planar mode is deleted;
an angular mode obtained by extending an angular mode whose angle is greater than or equal to a fourth threshold in the MPM list; or
an angular mode obtained by extending an angular mode whose angle is less than or equal to a fifth threshold in the MPM list.

In some embodiments, in the MPM list, the DC mode is after or before an angular mode constructed based on a neighboring block of the current block.

In some embodiments, in the mode list, the N angular modes are after or before an angular mode constructed based on a neighboring block of the current block.

In some embodiments, the first determining module 271 is configured to predict the template of the current block according to a sample value of a reference region of the template of the current block and the candidate prediction mode, to obtain the candidate prediction template, where the reference region comprises a non-adjacent region and/or an adjacent region of the template of the current block.

In some embodiments, the reference region includes an upper left region, an upper region, an upper right region, a left region, and/or a lower left region of the template of the current block.

In some embodiments, the first determining module 271 is configured to combine the candidate prediction mode in the mode list with a reference line in a reference line list of the template of the current block, to obtain a combination list; and predict the template of the current block according to the candidate prediction mode and the reference line that are indicated by a combination in the combination list, to obtain the candidate prediction template.

In some embodiments, a reference line index included in the reference line list is {1,3,5,7,12} or {1,4,5,7,10,12} or {1,2,3,7,10, 11}.

In some embodiments, the first determining module 271 is configured to: determine at least one candidate MV; and perform motion compensation on the template of the current block according to the candidate MV and a reference picture of the current block, to obtain the prediction template.

In some embodiments, the reference picture of the current block is a forward reference picture or a backward reference picture of the current block.

In some embodiments, the first determining module 271 is configured to obtain at least one candidate MV according to a Merge candidate list or an AMVP candidate list.

In some embodiments, the first determining module 271 is configured to obtain first N candidate MVs in the Merge candidate list or the AMVP candidate list.

In some embodiments, the candidate MV in the Merge candidate list or the AMVP candidate list is an MV subjected to template matching, DMVR, and/or Multipass DMVR refinement; and/or the candidate MV in the Merge candidate list or the AMVP candidate list is a candidate MV that is ranked according to an agreed sequence for an original candidate list.

In some embodiments, the first determining module 271 is configured to determine at least one candidate BV; and determine the prediction template of the template of the current block according to the candidate BV, the current block, and a current picture.

In some embodiments, the first determining module b 271 is configured to obtain the at least one candidate BV according to a Merge candidate list, an AMVP candidate list, and/or a preset value.

In some embodiments, the first determining module 271 is configured to obtain first N candidate BVs in the Merge candidate list or the AMVP candidate list.

In some embodiments, the preset value is equal to 0.

In some embodiments, the one or more prediction templates further include a first offset item, and the first offset item indicates a template generated according to a sample value bit depth of the template of the current block; and
the one or more first prediction blocks further include a second offset item, and the second offset item indicates a block generated according to a sample value bit depth of the current block.

In some embodiments, the one or more prediction templates further include a third offset item, and the third offset term indicates a prediction template obtained by predicting the template of the current block by using a specific prediction mode or a specific MV; and the one or more first prediction blocks further include a fourth offset item, and the fourth offset item is a prediction block obtained by predicting the current block by using the specific prediction mode or the specific MV.

In some embodiments, the specific prediction mode includes a Planar mode and/or a DC mode.

In some embodiments, the first determining module 271 is further configured to predict the template of the current block by using the specific prediction mode, in a case that it is determined that the specific prediction mode is different from an intra prediction mode indicated by the prediction parameter.

In some embodiments, the first determining module 271 is further configured to predict the template of the current block by using the specific MV, in a case that it is determined that the specific MV is different from an MV of the current block indicated by the prediction parameter.

In some embodiments, the one or more prediction templates further include a first non-linear item, and the first non-linear item indicates a prediction template obtained by performing transformation on a candidate prediction template with a minimum sample value error; and the one or more first prediction blocks further include a second non-linear item, and the second non-linear item indicates a prediction block obtained by performing transformation on a first prediction block corresponding to the candidate prediction template with the minimum sample value error.

In some embodiments, when a quantity of the one or more prediction templates is less than N, at least one of a first offset item, a third offset item, a first nonlinear item, or a first preset value is added to the prediction templates to obtain N prediction templates; and at least one of a second offset item, a fourth offset item, a second non-linear item, or a second preset value is added to the prediction blocks to obtain N first prediction blocks.

In some embodiments, the first preset value is equal to 0.

In some embodiments, the transformation includes square calculation.

In some embodiments, the one or more prediction templates further include a prediction template obtained by predicting the template of the current block by using an intermediate prediction mode when a fusion operation is not performed in Chroma Fusion, OBMC, MHP, and/or SGPM methods.

In some embodiments, the second determining module 272 is configured to determine the weight of the one or more prediction templates according to the template of the current block and the one or more prediction templates, so as to minimize a sample value error between the template of the current block and a target prediction value of the template of the current block, where the target prediction value is equal to a weighted sum of sample values of the one or more prediction templates.

In some embodiments, the second determining module 272 is configured to determine an autocorrelation matrix of the prediction template according to the sample value of the prediction template; determine a cross-correlation vector between the prediction template and the template of the current block according to the sample value of the prediction template and a sample value of the template of the current block; and determine the weight of the one or more prediction templates according to the autocorrelation matrix and the cross-correlation vector.

In some embodiments, a type of the sample value error is one of: MSE, SATD, SAD, MAD, MAE, NCC or SSE.

In some embodiments, the first fusion mode 274 is further configured to determine a residual block of the current block according to the second prediction block of the current block; and generate a bitstream according to the residual block.

Based on the foregoing embodiment, an embodiment of this application provides a decoding apparatus, applied to decoder. FIG. 28 is a schematic structural diagram of a decoding apparatus according to an embodiment of this application. As shown in FIG. 28, the decoding apparatus 28 includes: a fourth determining module 281, a fifth determining module 282, a sixth determining module 283, a second fusion module 284 and a seventh determining module 285.

The fourth determining module 281 is configured to determine a template of a current block and one or more prediction templates of the template of the current block.

The fifth determining module 282 is configured to determine a weight of the one or more prediction templates according to the template of the current block and the one or more prediction templates.

The sixth determining module 283 is configured to determine one or more first prediction blocks of the current block according to the prediction parameter of the current block.

The second fusion module 284 is configured to fuse the one or more first prediction blocks according to weights of the one or more prediction templates, to obtain a second prediction block of the current block.

The seventh determining module 285 is configured to determine a reconstruction value of the current block according to the second prediction block.

In some embodiments, the seventh determining module 285 is configured to decode a bitstream to determine a residual block corresponding to the current block; and determine a reconstruction value of the current block according to the residual block and the second prediction block.

In some embodiments, the sixth determining module 283 is configured to determine the first prediction block of the current block according to an intra prediction mode indicated by the prediction parameter.

In some embodiments, the sixth determining module 283 is configured to determine the first prediction block of the current block according to a motion parameter of the current block indicated by the prediction parameter.

In some embodiments, the motion parameter includes at least one of the following parameters: a motion vector, or a reference picture index.

In some embodiments, the prediction parameter of the current block is the same as a prediction parameter of the template of the current block.

In some embodiments, the fourth determining module 281 is configured to perform HoG calculation on a sample of the template of the current block to obtain a gradient direction and a gradient amplitude of the sample; determine an angular mode according to the gradient direction and the gradient amplitude; and
predict the template of the current block according to the angular mode, to obtain the prediction template.

In some embodiments, a fourth determining module 281 is configured to convert the gradient direction into a predefined candidate angular mode; and determine the angular mode from the candidate angular mode according to the gradient amplitude.

In some embodiments, the fourth determining module 281 is configured to: obtain N angular modes according to candidate angular modes corresponding to N maximum gradient amplitudes; and/or obtain one or more angular modes according to a candidate angular mode corresponding to a gradient amplitude greater than or equal to a first threshold; and/or obtain one or more angular modes according to a candidate angular mode corresponding to a second gradient amplitude, where a difference between the second gradient amplitude and at least one first gradient amplitude is less than or equal to a second threshold.

In some embodiments, a size of the at least one first gradient amplitude is adjacent to the second gradient amplitude.

In some embodiments, the fourth determining module 281 is configured to: predict the template of the current block according to a candidate prediction mode in a mode list, to obtain a candidate prediction template; and obtain the prediction template according to a sample value error between the candidate prediction template and the template of the current block.

In some embodiments, the fourth determining module 281 is configured to: obtain N prediction templates according to candidate prediction templates corresponding to N minimum sample value errors; or obtain the one or more prediction templates according to candidate prediction templates corresponding to a sample value error less than or equal to a third threshold.

In some embodiments, a type of the sample value error is at least one of: SATD, SAD, MAD, MAE, NCC, MSE or SSE.

In some embodiments, the candidate prediction mode in the mode list includes at least one of:
the angular mode obtained by performing the above steps;
a prediction mode in an MPM list;
a prediction mode in an MPM list in which a Planar mode is deleted;
an angular mode obtained by extending an angular mode whose angle is greater than or equal to a fourth threshold in the MPM list; or
an angular mode obtained by extending an angular mode whose angle is less than or equal to a fifth threshold in the MPM list

In some embodiments, in the MPM list, a DC mode is after or before an angular mode constructed based on a neighboring block of the current block.

In some embodiments, in the mode list, the N angular modes are after or before an angular mode constructed based on a neighboring block of the current block.

In some embodiments, the fourth determining module 281 is configured to: predict the template of the current block according to a sample value of a reference region of the template of the current block and the candidate prediction mode, to obtain the candidate prediction template, where the reference region includes a non-adjacent region and/or an adjacent region of the template of the current block.

In some embodiments, the reference region includes an upper left region, an upper region, an upper right region, a left region, and/or a lower left region of the template of the current block.

In some embodiments, the fourth determining module 281 is configured to: combine the candidate prediction mode in the mode list with a reference line in a reference line list of the template of the current block, to obtain a combination list; and predict the template of the current block according to the candidate prediction mode and the reference line that are indicated by a combination in the combination list, to obtain the candidate prediction template.

In some embodiments, a reference line index included in the reference line list is {1,3,5,7,12} or {1,4,5,7,10, 12} or {1,2,3,7, 10, 11}.

In some embodiments, a fourth determining mode block 281 is configured to: determine at least one candidate MV; and perform motion compensation on the template of the current block according to the candidate MV and a reference picture of the current block, to obtain the prediction template.

In some embodiments, the reference picture of the current block is a forward reference image or a backward reference image of the current block.

In some embodiments, the fourth determining module 281 is configured to obtain at least one candidate MV according to a Merge candidate list or an AMVP candidate list.

In some embodiments, the fourth determining module 281 is configured to a obtain first N candidate MVs in the Merge candidate list or the AMVP candidate list.

In some embodiments, the candidate MV in the Merge candidate list or the AMVP candidate list is an MV subjected to template matching, DMVR and/or Multipass DMVR refinement; and/or the candidate MV in the Merge candidate list or the AMVP candidate list is a candidate MV that is ranked according to an agreed sequence for an original candidate list.

In some embodiments, the fourth determining module 281 is configured to determine at least one candidate BV; and determine a prediction template of the template of the current block according to the candidate BV, the current block, and a current picture.

In some embodiments, the fourth determining module 281 is configured to obtain the at least one candidate BV according to the Merge candidate list, the AMVP candidate list and/or a preset value.

In some embodiments, the fourth determining module 281 is configured to obtain first N candidate BVs in the Merge candidate list or the AMVP candidate list.

In some embodiments, the preset value is equal to 0.

In some embodiments, the one or more prediction templates further includes a first offset item, and the first offset item indicates a template generated according to a sample value bit depth of the template of the current block; and the one or more first prediction block further includes a second offset item, and the second offset item indicates a block generated according to a sample value bit depth of the current block.

In some embodiments, the one or more prediction templates further include a third offset item, and the third offset item is a prediction template obtained by predicting the template of the current block according to a specific prediction mode or a specific MV; and the one or more first prediction blocks further include a fourth offset item, and the fourth offset item is a prediction block obtained by predicting the current block according to the specific prediction mode or the specific MV.

In some embodiments, the specific prediction mode includes a Planar mode and/or a DC mode.

In some embodiments, the fourth determining module 281 is further configured to predict the template of the current block according to the specific prediction mode, in a case that it is determined that the specific prediction mode is different from an intra prediction mode indicated by the prediction parameter.

In some embodiments, the fourth determining module 281 is further configured to predict the template of the current block according to the specific MV, in a case that it is determined that the specific MV is different from an MV of the current block indicated by the prediction parameter.

In some embodiments, the one or more prediction templates further include a first non-linear item, and the first non-linear item indicates a prediction template obtained by performing transformation on a candidate prediction template with a minimum sample value error; and the one or more first prediction blocks further include a second non-linear item, and the second non-linear item indicates a prediction block obtained by performing transformation on the first prediction block corresponding to the candidate prediction template with the minimum sample value error.

In some embodiments, when a quantity of the one or more prediction templates is less than N, at least one of a first offset item, a third offset item, a first nonlinear item or a first preset value is added to the prediction templates to obtain N prediction templates; and at least one of a second offset item, a fourth offset item, a second non-linear item or a second preset value is added to the first prediction blocks to obtain N first prediction blocks.

In some embodiments, the first preset value is equal to 0.

In some embodiments, the transformation includes square calculation.

In some embodiments, the one or more prediction templates further include a prediction template obtained by predicting the template of the current block by using an intermediate prediction mode when a fusion operation is not performed in Chroma Fusion, OBMC, MHP, and/or SGPM methods.

In some embodiments, the fifth determining module 282 is configured to determine the weight of the one or more prediction templates according to the template of the current block and the one or more prediction templates, so as to minimize a sample value error between the template of the current block and a target prediction value of the template of the current block, where the target prediction value is equal to a weighted sum of sample values of the one or more prediction templates.

In some embodiments, the fifth determining module 282 is configured to determine an autocorrelation matrix of the prediction template according to the sample value of the prediction template; determine a cross-correlation vector between the prediction template and the template of the current block according to the sample value of the prediction template and a sample value of the template of the current block; and determine the weight of the one or more prediction templates according to the autocorrelation matrix and the cross-correlation vector.

In some embodiments, a type of the sample value error is one of: MSE, SATD, SAD, MAD, MAE, NCC or SSE.

The foregoing description of the encoding/decoding apparatus embodiments is similar to the foregoing description of the encoding/decoding method embodiments, and the encoding/decoding apparatus can realize a similar beneficial effect. For technical details that are not disclosed in the apparatus embodiments of this application, reference may be made to the description of the encoding/decoding method embodiments of this application.

It should be noted that division of the modules of the apparatus in embodiments of this application is an example, and is merely logical function division. In actual implementation, there may be another division manner. In addition, functional units in the embodiments of this application may be integrated into one processing unit, or may exist separately physically, or two or more units may be integrated into one unit. The foregoing integrated unit may be implemented in a form of hardware, may be implemented in a form of a software functional unit, or may be implemented in a form of a combination of software and hardware.

It should be noted that, in embodiments of this application, if the foregoing method is implemented in a form of a software function module, and is sold or used as an independent product, the software function module may also be stored in a computer readable storage medium. Based on such an understanding, the technical solutions in the embodiments of this application essentially, or the part contributing to the related technologies, may be implemented in a form of a software product. The computer software product is stored in a storage medium and includes several instructions for instructing the electronic device to execute all or a part of the methods in the embodiments of this application. The foregoing storage medium includes any medium that can store program codes, such as a USB flash drive, a removable hard disk, a Read Only Memory (Read Only Memory, ROM), a magnetic disk, or an optical disc. In this way, embodiments of this application are not limited to any specific combination of hardware and software.

An embodiment of this application provides a computer readable storage medium, where the computer readable storage medium stores a computer program, and the computer program is executed to implement, for example, a method at an encoder side or a method at a decoder side.

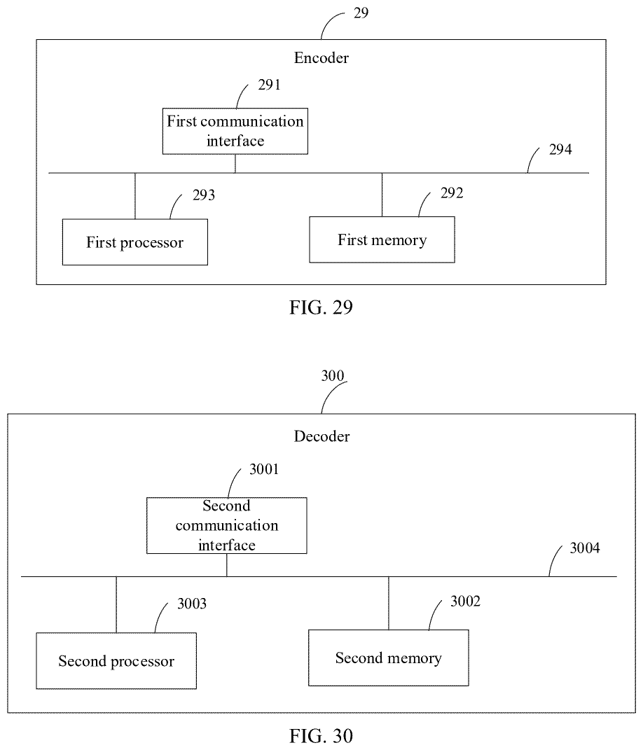

An embodiment of this application provides an encoder. As shown in FIG. 29, the encoder 29 includes a first communications interface 291, a first memory 292, and a first processor 293. Various components are coupled together by using the first bus system 294. It may be understood that the first bus system 294 is configured to implement connection and communication between these components. In addition to a data bus, the first bus system 294 further includes a power bus, a control bus, and a status signal bus. However, for clear description, various buses are marked as the first bus system 294 in FIG. 29.

The first communications interface 291 is configured to receive and transmit a signal in a process of transmitting and receiving information with another external network element.

The first memory 292 is configured to store a computer program that is runnable on the first processor 293.

The first processor 293 is configured to: run the computer program to execute the decoding method in embodiments of this application.

It may be understood that the first memory 292 in embodiments of this application may be a volatile memory or a non-volatile memory, or may include both a volatile memory and a non-volatile memory. The non-volatile memory may be a Read-Only Memory (ROM), a Programmable ROM (Programmable ROM, PROM), an Erasable PROM (Erasable PROM, EPROM), an Electrically EPROM (Electrically EPROM, EEPROM), or a flash memory. The volatile memory may be a Random Access Memory (RAM) that serves as an external cache. By way of examples rather than limitation, many forms of RAM are available, such as static RAM (Static RAM, SRAM), dynamic RAM (Dynamic RAM, DRAM), synchronous DRAM (Synchronous DRAM, SDRAM), Double Data Rate SDRAM (Double Data Rate SDRAM, DDRSDRAM), Enhanced SDRAM (Enhanced SDRAM, ESDRAM), Synchlink DRAM (Synchlink DRAM, SLDRAM) and Direct Rambus RAM (Direct Rambus RAM, DRRAM). The first memory 292 in the system and the method described in this application is intended to include but is not limited to these and any other suitable type of memory.

The first processor 293 may be an integrated circuit chip, and has a signal processing capability. In an implementation process, the steps of the foregoing methods may be completed by using an integrated logic circuit of hardware in the first processor 293 or an instruction in a form of software. The foregoing first processor 293 may be a general-purpose processor, a digital signal processor (DSP), an application-specific integrated circuit (ASIC), a Field Programmable Gate Array (FPGA) or another programmable logic device, a discrete gate or transistor logic device, or a discrete hardware component. The methods, steps, and logical block diagrams disclosed in the embodiments of this application may be implemented or executed. The general-purpose processor may be a microprocessor, or the processor may be any conventional processor or the like. The steps of the methods disclosed with reference to the embodiments of this application may be directly executed by a hardware decoding processor, or executed by a combination of hardware and software modules in the decoding processor. The software module may be located in a mature storage medium in the art such as a random access memory, a flash memory, a read-only memory, a programmable read-only memory, or an electrically erasable programmable memory or a register. The storage medium is located in the first memory 292. The first processor 293 reads information in the first memory 292 and completes the steps of the foregoing methods with reference to hardware of the first processor 293.

It may be understood that the embodiments described in this application may be implemented by hardware, software, firmware, middleware, microcode, or a combination thereof. For hardware implementation, the processing unit may be implemented in one or more of: an application specific integrated circuits (ASIC), a digital signal processor (DSP), a digital signal processing device (DSP Device, DSPD), a Programmable Logic Device (PLD), a field programmable gate array (FPGA), a general purpose processor, a controller, a microcontroller, a microprocessor, another electronic unit configured to perform the functions described in this application, or a combination thereof. For software implementation, the technology described in this application may be implemented by executing a module (for example, a process, a function, or the like) of the function described in this application. The software code may be stored in a memory and executed by a processor. The memory may be arranged in or outside the processor.

Optionally, in another embodiment, the first processor 293 is further configured to run the computer program to execute any one of the foregoing method embodiments on the encoding side.

An embodiment of this application provides a decoder. As shown in FIG. 30, the decoder 300 includes: a second communications interface 3001, a second memory 3002, and a second processor 3003. Various components are coupled together by using a second bus system 3004. It may be understood that the second bus system 3004 is configured to implement connection and communication between these components. In addition to a data bus, the second bus system 3004 further includes a power bus, a control bus, and a status signal bus. However, for clarity of description, various buses are marked as the second bus system 3004 in FIG. 300. The second communications interface 3001 is configured to receive and transmit a signal in a process of transmitting and receiving information between the second communications interface 3001 and another external network element.

The second memory 3002 is configured to store a computer program that is runnable on the second processor 3003.

The second processor 3003 is configured to run the computer program to execute the encoding method in embodiments of this application.

It may be understood that a hardware function of the second memory 3002 is similar to that of the first memory 3002, and a hardware function of the second processor 3003 is similar to that of the first processor 293. Details are not described herein.

An embodiment of this application provides an electronic device, including: a processor, configured to execute a computer program; and a computer readable storage medium, where the computer readable storage medium stores a computer program, and the computer program is executed by the processor to implement the encoding method and/or the decoding method in embodiments of this application. The electronic device may be various types of devices that have a video encoding and/or a video decoding capability. For example, the electronic device is a mobile phone, a tablet computer, a notebook computer, a personal computer, a television, a projection device, or a surveillance device.

It should be noted herein that descriptions of the foregoing storage medium and device embodiments are similar to descriptions of the foregoing method embodiments, and the storage medium and the device can realize beneficial effects similar to those of the method embodiments. For technical details not disclosed in the storage medium and the device embodiments of this application, reference may be made to the description in the method embodiments of this application.

It should be understood that “one embodiment” or “an embodiment” or “some embodiments” mentioned throughout the specification means that a specific feature, structure, or characteristic related to the embodiments is included in at least one embodiment of this application. Therefore, “in one embodiment” or “in an embodiment” or “in some embodiments” described throughout the specification does not necessarily refer to the same embodiment. In addition, these specific features, structures or characteristics may be combined in one or more embodiments in any suitable manner. It should be understood that in various embodiments of this application, a sequence number of the foregoing processes does not mean a sequence of execution. The execution sequence of the processes should be determined according to functions and internal logic of the processes, and should not constitute any limitation on an implementation process of the embodiments of this application. The foregoing sequence numbers of the embodiments of this application are merely for illustration, and do not represent of superiority or inferiority of the embodiments. The foregoing descriptions of the embodiments intend to emphasize differences between the embodiments. For a same or similar part between different embodiments, reference may be made to each other. For brevity, details are not described in this specification.

In this specification, the term “and/or” is merely an association relationship that describes an associated object, and indicates that three relationships may exist. For example, an object A and/or an object B may indicate that only the object A exists, both the object A and the object B exist, or only the object B exists.

It should be noted that in this specification, the term “include”, “comprise”, or any other variation thereof is intended to cover non-exclusive inclusion, so that a process, method, article, or apparatus that includes a series of elements includes not only those elements, but also other elements that are not explicitly listed, or further includes elements inherent to the process, method, article, or device. In the absence of more restrictions, an element defined by the statement “includes a . . . ” does not exclude that another same element exists in the process, method, article, or device that includes the element.

In the several embodiments provided in this application, it should be understood that the disclosed apparatus and method may be implemented in another manner. The described embodiments are merely schematic. For example, the module division is merely logical function division and may be other division in actual implementation. For example, a plurality of modules or components may be combined or integrated into another system, or some features may be ignored or not executed. In addition, the displayed or discussed mutual couplings or direct couplings or communication connections between components may be implemented by using some interfaces. The indirect couplings or communication connections between the apparatuses or modules may be implemented in electronic, mechanical, or other forms.

Modules described as separate components may be or may not be physically separate, and components displayed as modules may be or may not be physical modules, that is, may be located in one place or distributed on a plurality of network units. Some or all of the modules may be selected according to actual needs to achieve the objective of the solutions of the embodiments.

In addition, functional modules in embodiments of this application may be integrated into one processing unit, or each of the modules may be implemented as a separate unit, or two or more modules may be integrated into one unit. The integrated module may be implemented by hardware or by hardware plus a software functional unit.

A person of ordinary skill in the art may understand that all or some of the steps of the foregoing method embodiments may be implemented by using hardware related to a program instruction. The foregoing program may be stored in a computer readable storage medium, and the program is executed to performs the steps of the foregoing method embodiments. The foregoing storage medium includes any medium that can store program code, such as a mobile storage device, a Read Only Memory (ROM), a magnetic disk, or an optical disc.

Alternatively, if the integrated unit in this application is implemented in a form of a software function module and sold or used as an independent product, the integrated unit may also be stored in a computer readable storage medium. Based on such an understanding, the technical solutions in the embodiments of this application essentially, or the part contributing to the related technologies, may be implemented in a form of a software product. The computer software product is stored in a storage medium and includes several instructions for instructing the electronic device to execute all or a part of the methods in the embodiments of this application. The foregoing storage medium includes any medium that can store program code, such as a mobile storage device, a ROM, a magnetic disk, or an optical disc.

The methods disclosed in the several method embodiments provided in this application may be randomly combined without a conflict to obtain new method embodiments.

The features disclosed in the several product embodiments provided in this application may be randomly combined without a conflict to obtain a new product embodiment.

The features disclosed in the several method or device embodiments provided in this application may be randomly combined without a conflict to obtain a new method embodiment or device embodiment.

The foregoing descriptions are merely specific implementations of this application, but the protection scope of this application is not limited thereto. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. An encoding method, applied to an encoder, wherein the method comprises:
determining a template of a current block and one or more prediction templates of the template of the current block;
determining a weight of the one or more prediction templates according to the template of the current block and the one or more prediction templates;
determining one or more first prediction blocks of the current block according to a prediction parameter of the current block; and
fusing the one or more first prediction blocks by using the weight of the one or more prediction templates to obtain a second prediction block of the current block.

2. The method according to claim 1, wherein the first prediction block of the current block is determined according to an intra prediction mode indicated by the prediction parameter.

3. The method according to claim 1, wherein the determining the prediction template of the template of the current block comprises:
predicting the template of the current block according to a candidate prediction mode in a mode list, to obtain a candidate prediction template; and
obtaining the prediction template according to a sample value error between the candidate prediction template and the template of the current block.

4. The method according to claim 3, wherein the predicting the template of the current block according to the candidate prediction mode in the mode list to obtain the candidate prediction template comprises:
predicting the template of the current block according to a sample value of a reference region of the template of the current block and the candidate prediction mode, to obtain the candidate prediction template, wherein the reference region comprises a non-adjacent region and/or an adjacent region of the template of the current block.

5. The method of claim 4, wherein the reference region comprises an upper left region, an upper region, an upper right region, a left region, and/or a lower left region of the template of the current block.

6. The method according to claim 1, wherein the one or more prediction templates further comprise a prediction template obtained by predicting the template of the current block by using an intermediate prediction mode when a fusion operation is not performed in Chroma Fusion, OBMC, MHP, and/or SGPM methods.

7. The method according to claim 1, wherein the determining the weight of the one or more prediction templates according to the template of the current block and the one or more prediction templates comprises:
determining the weight of the one or more prediction templates according to the template of the current block and the one or more prediction templates, so as to minimize a sample value error between the template of the current block and a target prediction value of the template of the current block, wherein the target prediction value is equal to a weighted sum of sample values of the one or more prediction templates.

8. The method according to claim 7, wherein the determining the weight of the one or more prediction templates according to the template of the current block and the one or more prediction templates comprises:
determining an autocorrelation matrix of the prediction template according to the sample value of the prediction template;
determining a cross-correlation vector between the prediction template and the template of the current block according to the sample value of the prediction template and a sample value of the template of the current block; and
determining the weight of the one or more prediction templates according to the autocorrelation matrix and the cross-correlation vector.

9. The method of claim 7, wherein a type of the sample value error is one of: MSE, SATD, SAD, MAD, MAE, NCC or SSE.

10. A decoding method, applied to a decoder, wherein the method comprises:
determining a template of a current block and one or more prediction templates of the template of the current block;
determining a weight of the one or more prediction templates according to the template of the current block and the one or more prediction templates;
determining one or more first prediction blocks of the current block according to the prediction parameter of the current block;
fusing the one or more first prediction blocks by using the weight of the one or more prediction templates, to obtain a second prediction block of the current block; and
determining a reconstructed value of the current block according to the second prediction block.

11. The method according to claim 10, wherein the determining the reconstructed value of the current block according to the second prediction block comprises:
decoding a bitstream to determine a residual block corresponding to the current block; and
determining the reconstructed value of the current block according to the residual block and the second prediction block.

12. The method according to claim 10, wherein the first prediction block of the current block is determined according to an intra prediction mode indicated by the prediction parameter.

13. The method according to claim 10, wherein the determining a prediction template of the template of the current block comprises:
predicting the template of the current block according to a candidate prediction mode in a mode list, to obtain a candidate prediction template; and
obtaining the prediction template according to a sample value error between the candidate prediction template and the template of the current block.

14. The method according to claim 13, wherein the predicting the template of the current block according to a candidate prediction mode in a mode list to obtain a candidate prediction template comprises:
predicting the template of the current block according to a sample value of a reference region of the template of the current block and the candidate prediction mode, to obtain the candidate prediction template, where the reference region comprises a non-adjacent region and/or an adjacent region of the template of the current block.

15. The method of claim 14, wherein the reference region comprises an upper left region, an upper region, an upper right region, a left region, and/or a lower left region of the template of the current block.

16. The method according to claim 10, wherein the one or more prediction templates further comprise a prediction template obtained by predicting the template of the current block by using an intermediate prediction mode when a fusion operation is not performed in Chroma Fusion, OBMC, MHP, and/or SGPM methods.

17. The method according to claim 10, wherein the determining the weight of the one or more prediction templates according to the template of the current block and the one or more prediction templates comprises:
determining the weight of the one or more prediction templates according to the template of the current block and the one or more prediction templates, so as to minimize a sample value error between the template of the current block and a target prediction value of the template of the current block, wherein the target prediction value is equal to a weighted sum of sample values of the one or more prediction templates.

18. The method according to claim 17, wherein the determining the weight of the one or more prediction templates according to the template of the current block and the one or more prediction templates comprises:
determining an autocorrelation matrix of the prediction template according to the sample value of the prediction template;
determining a cross-correlation vector between the prediction template and the template of the current block according to the sample value of the prediction template and a sample value of the template of the current block; and
determining the weight of the one or more prediction templates according to the autocorrelation matrix and the cross-correlation vector.

19. The method according to claim 17, wherein a type of the sample value error is one of: MSE, SATD, SAD, MAD, MAE, NCC or SSE.

20. A computer readable storage medium storing a computer program/instruction and a bitstream, wherein the computer program/instruction is executed by a processor to implement the encoding method according to claim 1 to generate the bitstream.
